(19) United States
(12) Patent Application Publication
(10) Pub. No.: US 2024/0388343 A1
(43) Pub. Date: Nov. 21, 2024

(54) CSI CODEBOOK FOR MULTIPLE ANTENNA GROUPS

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/657,587

(22) Filed: May 7, 2024

Related U.S. Application Data
(60) Provisional application No. 63/467,910, filed on May 19, 2023.
(60) Provisional application No. 63/532,009, filed on Aug. 10, 2023.
(60) Provisional application No. 63/641,617, filed on May 2, 2024.

(51) Int. Cl. H04B 7/06; H04L 27/26

(52) U.S. Cl. CPC H04B 7/0626; H04B 7/0634; H04L 27/2636

(57) ABSTRACT

Apparatuses and methods for channel state information (CSI) codebook for multiple antenna groups. a method performed by a user equipment (UE) is provided. The method includes receiving information about a CSI report; determining the CSI report associated with N_{g} CSI reference signal (CSI-RS) resources; and transmitting the CSI report. The information indicates the N_{g} CSI-RS resources, where each of the N_{g} CSI-RS resources comprises 2N₁N₂ dual-polarized antenna ports. N₁ and N₂ are numbers of antenna ports associated with a same polarization in first and second dimensions, respectively. The CSI report includes: information of a spatial-domain (SD) basis vector vₗ that is common for two polarizations for the N_{g} CSI-RS resources for each layer, information of an inter-resource co-phase value c_{r,l} for a CSI-RS resource ∀r≠r* with respect to a reference CSI-RS resource r* for each layer, and information of an inter-polarization co-phase value φᵣ for a CSI-RS resource r.

### CROSS-REFERENCE TO RELATED AND CLAIM OF PRIORITY

The present application claims priority under 35 U.S.C. § 119 (e) to U.S. Provisional Patent Application No. 63/467,910 filed on May 19, 2023; U.S. Provisional Patent Application No. 63/532,009 filed on Aug. 10, 2023; and U.S. Provisional Patent Application No. 63/641,617 filed on May 2, 2024, which are hereby incorporated by reference in their entirety.

### TECHNICAL FIELD

The present disclosure relates generally to wireless communication systems and, more specifically, the present disclosure is related to apparatuses and methods for channel state information (CSI) codebook for multiple antenna groups.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to CSI codebook for multiple antenna groups.

In one embodiment, a user equipment (UE) is provided. The UE includes a transceiver configured to receive information about a channel state information (CSI) report. The information indicates N_{g} CSI reference signal (CSI-RS) resources, where N_{g}>1 and each of the N_{g} CSI-RS resources comprises 2N₁N₂ dual-polarized antenna ports. N₁ and N₂ are numbers of antenna ports associated with a same polarization in first and second dimensions, respectively. The UE further includes a processor operably coupled to the transceiver. The processor, based on the information, is configured to measure the N_{g} CSI-RS resources and determine the CSI report associated with the N_{g} CSI-RS resources. The CSI report includes: information of a spatial-domain (SD) basis vector vₗ that is common for two polarizations for the N_{g} CSI-RS resources for each layer l=1, · · · , v, where v≥1 is a rank value, information of an inter-resource co-phase value c_{r,l} for a CSI-RS resource ∀r≠r* with respect to a reference CSI-RS resource r* for layer l, and information of an inter-polarization co-phase value φᵣ for a CSI-RS resource r. The transceiver is further configured to transmit the CSI report.

In another embodiment, a base station (BS) is provided. The BS includes a processor and a transceiver operably coupled to the processor. The transceiver is configured to transmit information about a CSI report, transmit on N_{g} CSI-RS resources, and receive the CSI report associated with the N_{g} CSI-RS resources. The information indicates the N_{g} CSI-RS resources, where N_{g}>1 and each of the N_{g} CSI-RS resources comprises 2N₁N₂ dual-polarized antenna ports. N₁ and N₂ are numbers of antenna ports associated with a same polarization in first and second dimensions, respectively. The CSI report includes: information of a SD basis vector vₗ that is common for two polarizations for the N_{g} CSI-RS resources for each layer l=1, · · · , v, where v≥1 is a rank value, information of an inter-resource co-phase value c_{r,l} for a CSI-RS resource ∀r≠r* with respect to a reference CSI-RS resource r* for layer l, and information of an inter-polarization co-phase value φᵣ for a CSI-RS resource r.

In yet another embodiment, a method performed by a UE is provided. The method includes receiving information about a CSI report; based on the information, measuring N_{g} CSI-RS resources and determining the CSI report associated with the N_{g} CSI-RS resources; and transmitting the CSI report. The information indicates the N_{g} CSI-RS resources, where N_{g}>1 and each of the N_{g} CSI-RS resources comprises 2N₁N₂ dual-polarized antenna ports. N₁ and N₂ are numbers of antenna ports associated with a same polarization in first and second dimensions, respectively. The CSI report includes: information of a SD basis vector vₗ that is common for two polarizations for the N_{g} CSI-RS resources for each layer l=1, · · · , v, where v≥1 is a rank value, information of an inter-resource co-phase value c_{r,l} for a CSI-RS resource ∀r≠r* with respect to a reference CSI-RS resource r* for layer l, and information of an inter-polarization co-phase value φᵣ for a CSI-RS resource r.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example of a distributed MIMO (DMIMO) according to embodiments of the present disclosure;

FIG. 11 illustrates an example of a timeline for channel measurement with and without Doppler components according to embodiments of the present disclosure;

FIG. 12 illustrates a diagram of an antenna port layout according to embodiments of the present disclosure;

FIG. 13 illustrates a diagram of an example 3D grid of direct Fourier transform (DFT) beams according to embodiments of the present disclosure;

FIG. 14 illustrates an example of a UE moving on a trajectory located in a distributed MIMO according to embodiments of the present disclosure;

FIG. 15 illustrates examples of a UE moving on a trajectory located in co-located and distributed transmit-receive points (TRP) according to embodiments of the present disclosure;

FIG. 16 illustrates an example of a timeline for a UE to receive non-zero-power (NZP) channel state information reference signal (CSI-RS) resource(s) bursts according to embodiments of the present disclosure;

FIG. 17 illustrates examples of timelines for partitioned CSI-RS burst instances according to embodiments of the present disclosure;

FIG. 18 illustrates an example of a timeline for resource block (RB) and subband (SB) partitions according to embodiments of the present disclosure;

FIG. 19 illustrates a diagram of an example number of CSI-RS resource groups according to embodiments of the present disclosure;

FIG. 20 illustrates a diagram of an example number of CSI-RS resource groups according to embodiments of the present disclosure;

FIG. 21 illustrates a diagram of an example number of CSI-RS resource groups according to embodiments of the present disclosure;

FIG. 22 illustrates a diagram of an example number of CSI-RS resource groups according to embodiments of the present disclosure;

FIG. 23 illustrates a diagram of an example number of CSI-RS resource groups according to embodiments of the present disclosure;

FIG. 24 illustrates a diagram of an example number of CSI-RS resources according to embodiments of the present disclosure;

FIG. 25 illustrates a diagram of an example number of CSI-RS resource groups according to embodiments of the present disclosure;

FIG. 26 illustrates a diagram of an example number of CSI-RS resource groups according to embodiments of the present disclosure;

FIG. 27 illustrates a diagram of an example number of CSI-RS resource groups according to embodiments of the present disclosure; and

FIG. 28 illustrates an example method performed by a UE in a wireless communication system according to embodiments of the present disclosure.

### DETAILED DESCRIPTION

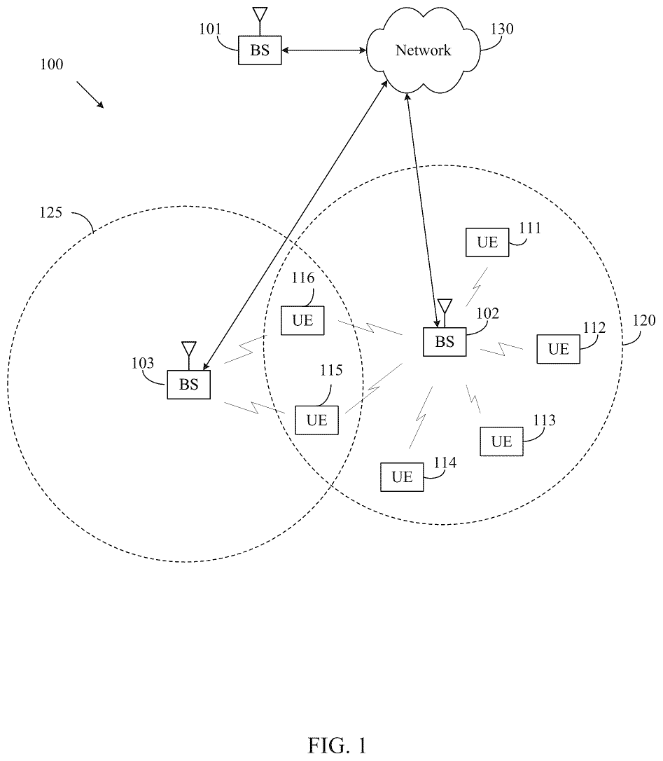

FIGS. 1-28, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 36.211 v17.0.0, “E-UTRA, Physical channels and modulation;” [2] 3GPP TS 36.212 v17.0.0, “E-UTRA, Multiplexing and Channel coding;” [3] 3GPP TS 36.213 v17.0.0, “E-UTRA, Physical Layer Procedures;” [4] 3GPP TS 36.321 v17.0.0, “E-UTRA, Medium Access Control (MAC) protocol specification;” [5] 3GPP TS 36.331 v17.0.0, “E-UTRA, Radio Resource Control (RRC) Protocol Specification;” [6] 3GPP TR 22.891 v1.2.0; [7] 3GPP TS 38.212 v17.4.0, “E-UTRA, NR, Multiplexing and Channel coding;” [8] 3GPP TS 38.214 v17.4.0, “E-UTRA, NR, Physical layer procedures for data;” [9] RP-192978, “Measurement results on Doppler spectrum for various UE mobility environments and related CSI enhancements,” Fraunhofer IIS, Fraunhofer HHI, Deutsche Telekom; [10] 3GPP TS 38.211 v17.4.0, “E-UTRA, NR, Physical channels and modulation;” [11] 3GPP TS 38.213 v17.4.0, “E-UTRA, NR, Physical layer procedures for control;” and [12] 3GPP TS 38.306 v17.4.0, “E-UTRA, NR, User Equipment (UE) radio access capabilities.”

FIGS. 1-28 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing a CSI codebook for multiple antenna groups. In certain embodiments, one or more of the BSs 101-103 include circuitry, programing, or a combination thereof to support a CSI codebook for multiple antenna groups.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for a CSI codebook for multiple antenna groups. Any of a wide variety of other functions could be supported in the gNB 102 by the controller/processor 225.

The controller/processor 225 is also capable of executing programs and other processes resident in the memory 230, such as processes to support a CSI codebook for multiple antenna groups. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

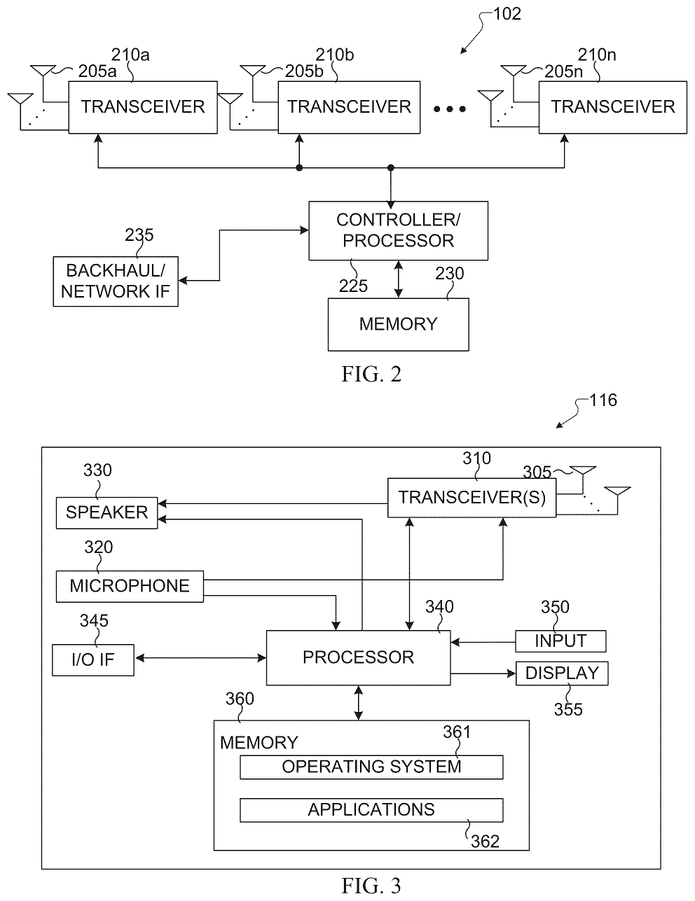

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing a CSI codebook for multiple antenna groups as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

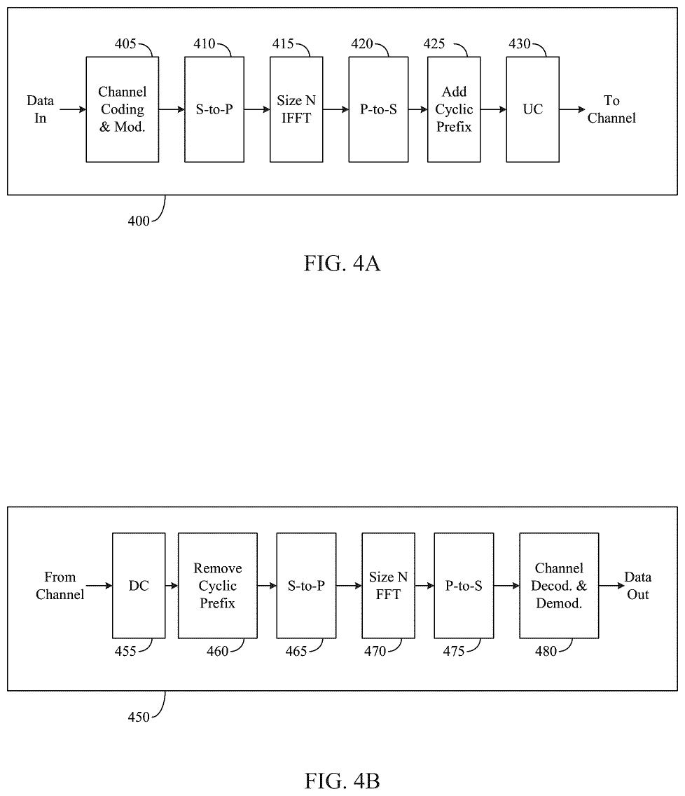

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured to support or utilize a CSI codebook for multiple antenna groups as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

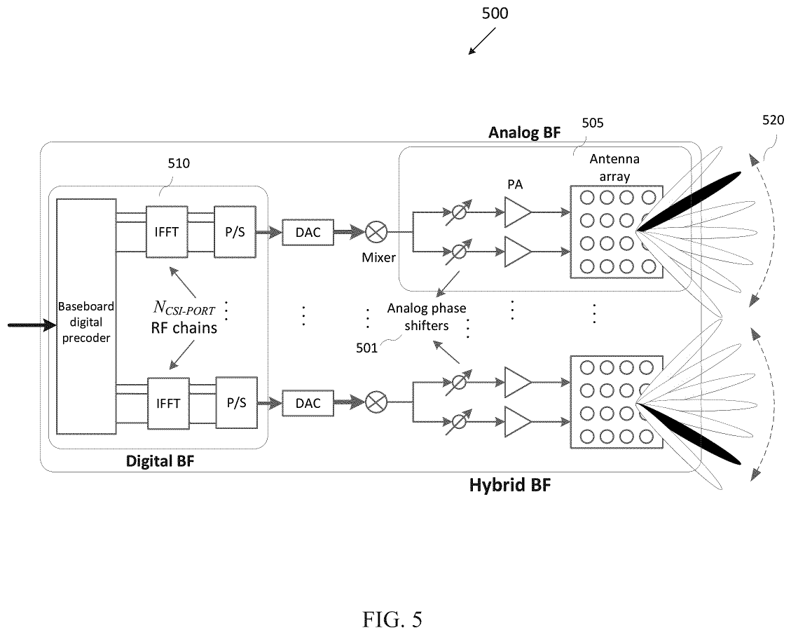

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NeSI-PORT. A digital beamforming unit 510 performs a linear combination across NeSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

To enable digital precoding, efficient design of CSI-RS is a crucial factor. For this reason, three types of CSI reporting mechanism corresponding to three types of CSI-RS measurement can be evaluated: 1) ‘CLASS A’ CSI reporting which corresponds to non-precoded CSI-RS, 2) ‘CLASS B’ reporting with K=1 CSI-RS resource which corresponds to UE-specific beamformed CSI-RS, and 3) ‘CLASS B’ reporting with K>1 CSI-RS resources which corresponds to cell-specific beamformed CSI-RS. For non-precoded (NP) CSI-RS, a cell-specific one-to-one mapping between CSI-RS port and transceiver unit (TXRU) is utilized. Here, different CSI-RS ports have the same wide beam width and direction and hence generally cell wide coverage. For beamformed CSI-RS, beamforming operation, either cell-specific or UE-specific, is applied on a non-zero-power (NZP) CSI-RS resource (including multiple ports). Here, (at least at a given time/frequency) CSI-RS ports have narrow beam widths and hence not cell wide coverage, and (at least from the eNB (or gNB) perspective) at least some CSI-RS port-resource combinations have different beam directions.

In scenarios where DL long-term channel statistics can be measured through UL signals at a serving eNodeB, UE-specific beamforming (BF) CSI-RS can be readily used. This is typically feasible when UL-DL duplex distance is sufficiently small. However, when this condition does not hold, some UE feedback is essential for the eNodeB to obtain an estimate of DL long-term channel statistics (or any of its representation thereof). To facilitate such a procedure, a first BF CSI-RS transmitted with periodicity T1 (ms), and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

The present disclosure relates generally to wireless communication systems and, more specifically, to compression-based CSI reporting.

A communication system includes a downlink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL Control Information (DCI), and Reference Signals (RS) that are also known as pilot signals. An eNodeB transmits data information through a Physical DL Shared Channel (PDSCH). An eNodeB transmits DCI through a Physical DL Control Channel (PDCCH) or an Enhanced PDCCH (EPDCCH)—see also document and standard [3]. An eNodeB transmits acknowledgement information in response to data Transport Block (TB) transmission from a UE in a Physical Hybrid Automatic Repeat Request Indicator Channel (PHICH). An eNodeB transmits one or more of multiple types of RS including a UE-Common RS (CRS), a Channel State Information RS (CSI-RS), or a DeModulation RS (DMRS). A CRS is transmitted over a DL system BandWidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe (or slot) and can have, for example, duration of 1 millisecond.

DL signals also include transmission of a logical channel that carries system control information. A broadcast control channel (BCCH) is mapped to either a transport channel referred to as a Broadcast Channel (BCH) when it conveys a Master Information Block (MIB) or to a DL Shared Channel (DL-SCH) when it conveys a System Information Block (SIB)—see also document and standard [3] and document and standard [5]. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW incudes frequency resource units referred to as Resource Blocks (RBs). Each RB includes N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or Physical UL Control Channel (PUCCH). An eNodeB can use a DMRS to demodulate data signals or UCI signals. A UE transmits SRS to provide an eNodeB with an UL CSI. A UE transmits data information or UCI through a respective PUSCH or a PUCCH. If a UE requires to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/enhanced PDCCH (EPDCCH) indicating a release of semi-persistently scheduled PDSCH (see also document and standard [3]).

An UL subframe (or slot) includes two slots. Each slot includes N_{symb}^{UL} symbols for transmitting data information, UCI, DMRS, or SRS. A frequency resource unit of an UL system BW is an RB. A UE is allocated N_{RB} RBs for a total of N_{RB}·N_{sc}^{RB} REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is N_{symb}=2· (N_{symb}^{UL}−1)−N_{SRS}, where N_{SRS}=1 if a last subframe (or slot) symbol is used to transmit SRS and N_{SRS}=0 otherwise.

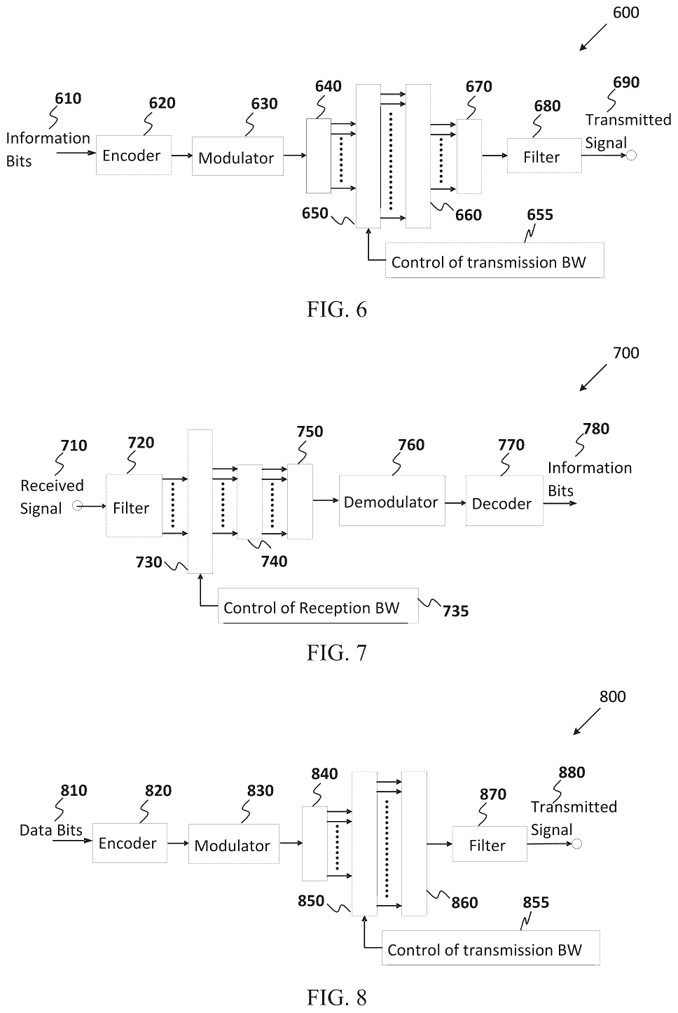

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

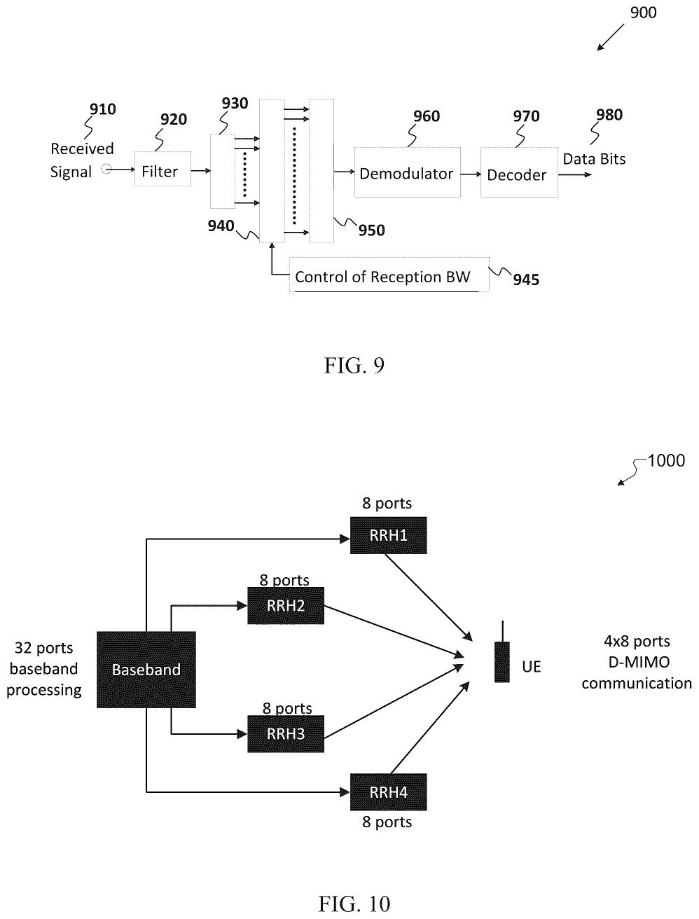

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

In next generation cellular systems, various use cases are envisioned beyond the capabilities of LTE. Termed 5G or the fifth generation cellular system, a system capable of operating at sub-6 GHz and above-6 GHz (for example, in mmWave regime) becomes one of the requirements. In document and standard [6], 74 5G use cases has been identified and described; those use cases can be roughly categorized into three different groups. A first group is termed ‘enhanced mobile broadband’ (eMBB), targeted to high data rate services with less stringent latency and reliability requirements. A second group is termed ‘ultra-reliable and low latency’ (URLL) targeted for applications with less stringent data rate requirements, but less tolerant to latency. A third group is termed ‘massive MTC’ (mMTC) targeted for large number of low-power device connections such as 1 million per km² with less stringent the reliability, data rate, and latency requirements.

The 3GPP specification (such as 4G LTE and 5G NR) supports up to 32 CSI-RS antenna ports which enable an eNB (or gNB) to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

In a wireless communication system, MIMO is often identified as key feature in order to achieve high system throughput requirements. One of the key components of a MIMO transmission scheme is the accurate CSI acquisition at the eNB (or gNB) (or TRP). For multi-user MIMO (MU-MIMO), in particular, the availability of accurate CSI is essential in order to guarantee high MU performance. For time division duplexing (TDD) systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE. In common FDD systems, the CSI feedback framework is ‘implicit’ in the form of channel quality indicator (CQI)/precoding matrix indicator (PMI)/rank indicator (RI) (also CSI reference signal identity (CRI) and layer identity (LI)) derived from a codebook implying SU transmission from eNB (or gNB).

In 5G or NR systems ([document and standard [7], document and standard [8]), the herein-mentioned “implicit” CSI reporting paradigm from LTE is also supported and referred to as Type I CSI reporting. In addition, a high-resolution CSI reporting, referred to as Type II CSI reporting, is also supported in Release 15 specification to provide more accurate CSI information to gNB for use cases such as high-order MU-MIMO. However, embodiments of the present disclosure recognize the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in document and standard [8]). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising each component) requires to be reported by the UE (e.g., the UE 116). However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in document and standard [8]), wherein the DFT-based SD basis in W₁ is replaced with SD CSI-RS port selection, i.e., L out of P_{CSI-RS}/2 CSI-RS ports are selected (the selection is common for the two antenna polarizations or two halves of the CSI-RS ports). The CSI-RS ports in this case are beamformed in SD (UL-DL channel reciprocity in angular domain), and the beamforming information can be obtained at the gNB 102 based on UL channel estimated using SRS measurements.

In Rel. 17 NR, CSI reporting has been enhanced to support the following:
Further enhanced Type II port selection codebook: it has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD or/and M ports are selected in FD. The CSI-RS ports in this case are beamformed in SD (UL-DL channel reciprocity in angular domain) or/and FD (UL-DL channel reciprocity in delay/frequency domain), and the corresponding SD or/and FD beamforming information can be obtained at the gNB 102 based on UL channel estimated using SRS measurements. In Rel. 17, such a codebook is supported (which is referred to as Rel. 17 further enhanced Type II port selection codebook in document and standard [8]).
Non-coherent joint transmission (NCJT) CSI reporting: When the UE can communicate with multiple TRPs that are distributed at different locations in space (e.g., within a cell), the CSI reporting can correspond to a single TRP hypothesis (i.e., CSI reporting for one of the multiple TRPs) or multi-TRP hypothesis (i.e., CSI reporting for at least two of the multiple TRPs). The CSI reporting for both single TRP and multi-TRP hypotheses are supported in Rel. 17. However, the multi-TRP CSI reporting imply a NCJT, i.e., a layer (and precoder) of the transmission is restricted to be transmitted from only one TRP.

In Rel. 18 MIMO WID includes the following objectives on CSI enhancements:
Study, and if justified, specify enhancements of CSI acquisition for Coherent-JT targeting FR1 and up to 4 TRPs, implying ideal backhaul and synchronization as well as the same number of antenna ports across TRPs, as follows:
   Rel-16/17 Type-II codebook refinement for coherent joint transmission (CJT) multi-TRP (mTRP) targeting FDD and its associated CSI reporting, taking into account throughput-overhead trade-off.
Study, and if justified, specify CSI reporting enhancement for high/medium UE velocities by exploiting time-domain correlation/Doppler-domain information to assist DL precoding, targeting FR1, as follows:
   Rel-16/17 Type-II codebook refinement, without modification to the spatial and frequency domain basis.
   UE reporting of time-domain channel properties measured via CSI-RS for tracking.

The first objective extends the Rel.17 NCJT CSI to coherent JT (CJT), and the second extends FD compression in the Rel.16/17 codebook to include time (Doppler) domain compression. Both extensions are based on the same common codebook, i.e., Rel. 16/17 codebook. In the present disclosure, a unified codebook design evaluating both extensions have been provided.

FIG. 10 illustrates an example of a DMIMO according to embodiments of the present disclosure. For example, the DMIMO 1000 may be implemented by one or more BSs such as BS 102. The DMIMO 1000 is for illustration only and other embodiments can be used without departing from the scope of the present disclosure.

The main use case or scenario of interest for CJT/DMIMO is as follows. Although NR supports up to 32 CSI-RS antenna ports, for a cellular system operating in a sub-1 GHz frequency range (e.g., less than 1 GHz), supporting large number of CSI-RS antenna ports (e.g., 32) at one site or remote radio head (RRH) or TRP is challenging due to larger antenna form factors at these frequencies (when compared with a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) cannot be achieved. One way to operate a sub-1 GHz system with large number of CSI-RS antenna ports is based on distributing antenna ports at multiple sites (or RRHs). The multiple sites or RRHs can still be connected to a single (common) baseband unit, hence the signal transmitted/received via multiple distributed RRHs can still be processed at a centralized location. For example, 32 CSI-RS ports can be distributed across 4 RRHs, each with 8 antenna ports. Such a MIMO system can be referred to as a distributed MIMO (D-MIMO) or a CJT system.

The multiple RRHs in a D-MIMO setup can be utilized for spatial multiplexing gain (based on CSI reporting). Since RRHs are geographically separated, they (RRHs) tend to contribute differently to CSI reporting. This motivates a dynamic RRH selection followed by CSI reporting condition on the RRH selection. The present disclosure provides example embodiments on how channel and interference signal can be measure under different RRH selection hypotheses. Additionally, the signaling details of such a CSI reporting and CSI-RS measurement are also provided.

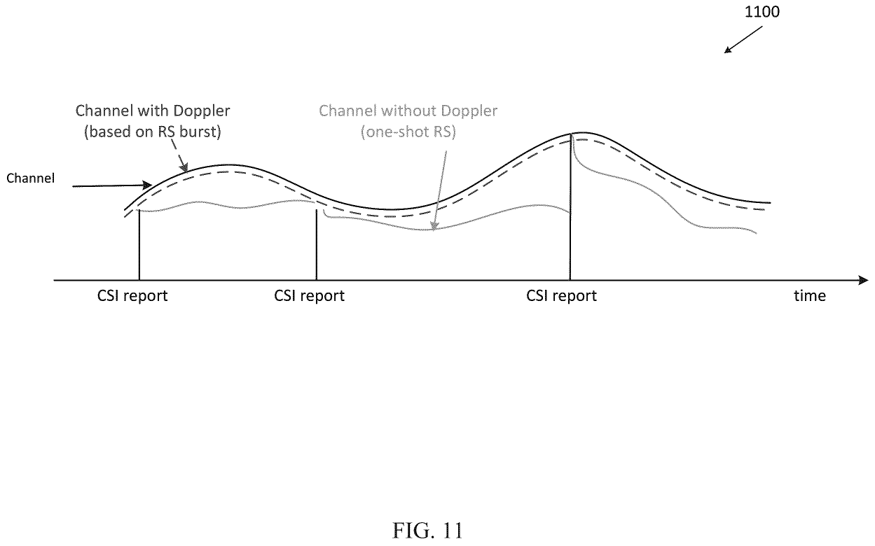

FIG. 11 illustrates an example of a timeline 1100 for channel measurement with and without Doppler components according to embodiments of the present disclosure. For example, timeline 1100 for channel measurement with and without Doppler components can be followed by the UE 112 of FIG. 1. This example is for illustration only and can be used without departing from the scope of the present disclosure.

The main use case or scenario of interest for time-/Doppler-domain compression is moderate to high mobility scenarios. When the UE's speed is in a moderate or high speed regime, the performance of the Rel. 15/16/17 codebooks starts to deteriorate quickly due to fast channel variations (which in turn is due to UE mobility that contributes to the Doppler component of the channel), and a one-shot nature of CSI-RS measurement and CSI reporting in Rel. 15/16/17. This limits the usefulness of Rel. 15/16/17 codebooks to low mobility or static UEs only. For moderate or high mobility scenarios, an enhancement in CSI-RS measurement and CSI reporting is called for, which is based on the Doppler components of the channel. As described in document and standard [9], the Doppler components of the channel remain almost constant over a large time duration, referred to as channel stationarity time, which is significantly larger than the channel coherence time. Note that the current (Rel. 15/16/17) CSI reporting is based on the channel coherence time, which is not suitable when the channel has significant Doppler components. The Doppler components of the channel can be calculated based on measuring a reference signal (RS) burst, where the RS can be CSI-RS or SRS. When RS is CSI-RS, the UE measures a CSI-RS burst, and use it to obtain Doppler components of the DL channel, and when RS is SRS, the gNB 102 measures an SRS burst, and use it to obtain Doppler components of the UL channel. The obtained Doppler components can be reported by the UE using a codebook (as part of a CS report). Or the gNB 102 can use the obtained Doppler components of the UL channel to beamform CSI-RS for CSI reporting by the UE. When the channel is measured with the Doppler components (e.g., based on an RS burst), the measured channel can remain close to the actual varying channel. On the other hand, when the channel is measured without the Doppler components (e.g., based on a one-shot RS), the measured channel can be far from the actual varying channel.

The present disclosure relates to CSI acquisition at gNB. In particular, it relates to the CSI reporting based on a high-resolution (or Type II) codebook comprising spatial-, frequency- or/and time-(Doppler-) domain components for a distributed antenna structure (DMIMO). The 3 most novel aspects are as follows:
CSI processing unit based on multiple CSI-RS resource(s) configuration, and optional features such as CSI-RS resource selection and a number of spatial-domain combinations N_{g} for CJT codebook;
CSI processing unit based on multiple CSI-RS resource(s) configuration, Wₘₑₐₛ a number of CSI-RS measurement occasion(s) for Doppler codebook;
Simple scaling extension of PUSCH preparation time and UE computational time for CJT/Doppler codebook CSI reporting.

Aspects, features, and advantages of the present disclosure are readily apparent from the following detailed description, simply by illustrating a number of particular embodiments and implementations, including the best mode contemplated for carrying out the present disclosure. Embodiments of the present disclosure also capable of other and different embodiments, and its several details can be modified in various obvious respects, all without departing from the spirit and scope of the present disclosure. Accordingly, the drawings and description are to be regarded as illustrative in nature, and not as restrictive. Embodiments of the present disclosure are illustrated by way of example, and not by way of limitation, in the figures of the accompanying drawings.

In the following, for brevity, both FDD and TDD are regarded as the duplex method for both DL and UL signaling.

Although exemplary descriptions and embodiments to follow imply orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure covers several components which can be used in conjunction or in combination with one another or can operate as standalone schemes.

Each of the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, each of the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include each of the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤ N CSI reporting bands. For instance, >6 GHz, large system bandwidth may be called for multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for each of the Mₙ subbands within the CSI reporting band. A CSI parameter is configured with “subband” for the CSI reporting band with Mₙ subbands when one CSI parameter is reported for each of the Mₙ subbands within the CSI reporting band.

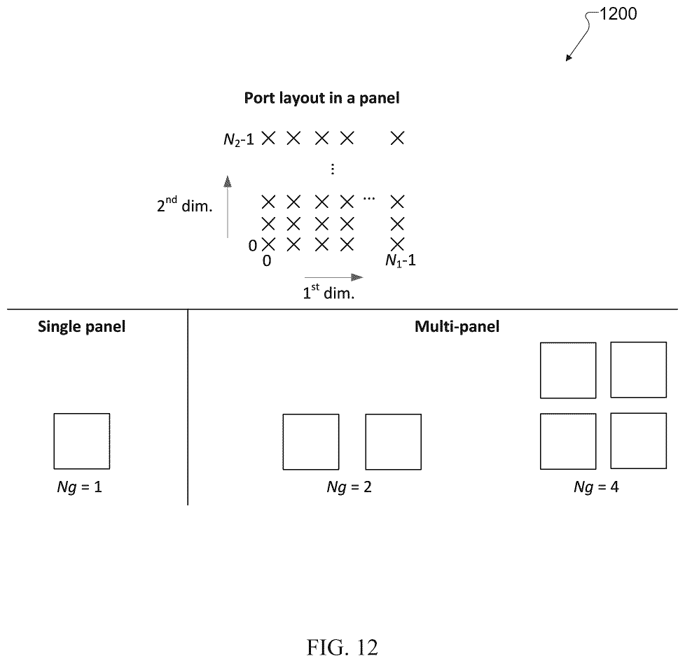

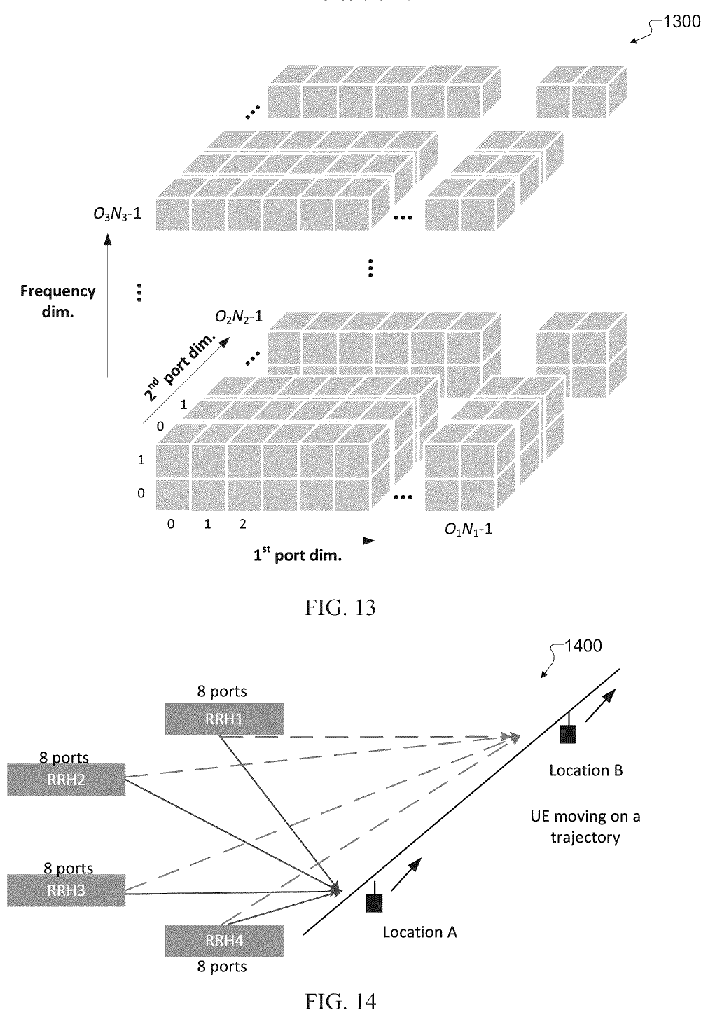

FIG. 12 illustrates a diagram of an antenna port layout 1200 according to embodiments of the present disclosure. For example, antenna port layout 1200 of an antenna port layout can be implemented by the BS 102 of FIG. 2. This example is for illustration only and can be used without departing from the scope of the present disclosure.

With reference to FIGS. 12, N₁ and N₂ are the number of antenna ports with the same polarization in the first and second dimensions, respectively. For 2D antenna port layouts, N₁>1, N₂>1, and for 1D antenna port layouts N₁>1 and N₂=1. So, for a dual-polarized antenna port layout, the total number of antenna ports is 2N₁N₂ when each antenna maps to an antenna port. “X” represents two antenna polarizations. In the present disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Let N_{g} be a number of antenna panels at the gNB 102. When there are multiple antenna panels (N_{g}>1), it is implied that each panel is dual-polarized antenna ports with N₁ and N₂ ports in two dimensions. Note that the antenna port layouts may or may not be the same in different antenna panels.

In one example, the antenna architecture of a D-MIMO or coherent joint transmission (CJT) system is structured. For example, the antenna structure at each RRH (or TRP) is dual-polarized (single or multi-panel as shown FIG. 12). The antenna structure at each RRH/TRP can be the same. Or the antenna structure at an RRH/TRP can be different from another RRH/TRP. Likewise, the number of ports at each RRH/TRP can be the same. Or the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

Embodiments of the present disclosure imply a structured antenna architecture in the rest of the present disclosure. For simplicity, each RRH/TRP is equivalent to a panel, although an RRH/TRP can have multiple panels in practice. However, the present disclosure is not restrictive to a single panel at each RRH/TRP and can easily be extended (covers) the case when an RRH/TRP has multiple antenna panels.

In one embodiment, an RRH constitutes (or corresponds to or is equivalent to) at least one of the following:
In one example, an RRH corresponds to a TRP.
In one example, an RRH or TRP corresponds to a CSI-RS resource. A UE is configured with K=N_{RRH}>1 non-zero-power (NZP) CSI-RS resources and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained herein.
In one example, an RRH or TRP corresponds to a CSI-RS resource group, where a group comprises one or multiple NZP CSI-RS resources. A UE is configured with K≥ N_{RRH}>1 non-zero-power (NZP) CSI-RS resources and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in the present disclosure. In particular, the K CSI-RS resources can be partitioned into N_{RRH} resource groups. The information about the resource grouping can be provided together with the CSI-RS resource setting/configuration, or with the CSI reporting setting/configuration, or with the CSI-RS resource configuration.
In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.
In one example an RRH or TRP corresponds to one or more examples described herein depending on a configuration. For example, this configuration can be explicit via a parameter (e.g., an RRC parameter). Or it can be implicit.
   In one example, when implicit, it could be based on the value of K. For example, when K>1 CSI-RS resources, an RRH corresponds to example, and when K=1 CSI-RS resource, an RRH corresponds to one or more examples described herein.
   In another example, the configuration could be based on the configured codebook. For example, an RRH corresponds to a CSI-RS resource or resource group when the codebook corresponds to a decoupled codebook (modular or separate codebook for each RRH), and an RRH corresponds to a subset (or a group) of CSI-RS ports when codebook corresponds to a coupled (joint or coherent) codebook (one joint codebook across RRHs).

In one example, when RRH or TRP maps (or corresponds to) a CSI-RS resource or resource group, and a UE can select a subset of RRHs (resources or resource groups) and report the CSI for the selected RRHs (resources or resource groups). The selected RRHs can be reported via an indicator. For example, the indicator can be a CRI or a PMI (component) or a new indicator.

In one example, when RRH maps (or corresponds to) a CSI-RS port group, and a UE can select a subset of RRHs (port groups) and report the CSI for the selected RRHs (port groups). The selected RRHs can be reported via an indicator. For example, the indicator can be a CRI or a PMI (component) or a new indicator.

In one example, when multiple (K>1) CSI-RS resources are configured for N_{RRH} RRHS, a decoupled (modular) codebook is used/configured, and when a single (K=1) CSI-RS resource for N_{RRH} RRHs, a joint codebook is used/configured.

FIG. 13 illustrates a diagram 1300 of an example 3D grid of DFT beams according to embodiments of the present disclosure. For example, diagram 1300 can be implemented by the BS 102 of FIG. 1. This example is for illustration only and can be used without departing from the scope of the present disclosure.

As described in U.S. Pat. No. 10,659,118 issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination based Type II CSI reporting framework is extended to include frequency dimension in addition to the 1^{st} and 2^{nd} antenna port dimensions. With reference to FIG. 13, the following is shown:
1^{st} dimension is associated with the 1^{st} port dimension,
2^{nd} dimension is associated with the 2^{nd} port dimension, and
3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors Oᵢ belongs to {2, 4, 8}. In yet another example, at least one of O₁,O₂, and O₃ is higher layer configured (via RRC signaling).

As explained in document and standard [8], a UE is configured with higher layer parameter codebookType set to ‘typeII-PortSelection-r16’ for an enhanced Type II CSI reporting in which the pre-coders for each of the SBs and for a given layer l=1, . . . , v, where v is the associated RI value, is given by either

$${W}^{l} = {AC}_{l} {B}^{H} = [ \begin{matrix}{a}_{0} & {a}_{1} & … & {a}_{L - 1}\end{matrix} ] \qquad ( Eq . 1 )$$

$${[ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ \begin{matrix}{b}_{0} & {b}_{1} & … & {b}_{M - 1}\end{matrix} ]}^{H} =$$

$${\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) ,$$

$$or$$

$${W}^{l} = [ \begin{matrix}A & 0 \\ 0 & A\end{matrix} ] {C}_{l} {B}^{H} = [ \begin{matrix}\begin{matrix}{a}_{0} & {a}_{1} & … & {a}_{L - 1}\end{matrix} & 0 \\ 0 & \begin{matrix}{a}_{0} & {a}_{1} & … & {a}_{L - 1}\end{matrix}\end{matrix} ] \qquad ( Eq . 2 )$$

$${[ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ \begin{matrix}{b}_{0} & {b}_{1} & … & {b}_{M - 1}\end{matrix} ]}^{H} =$$

$$[ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] ,$$

where:
N₁ is a number of antenna ports in a first antenna port dimension (having the same antenna polarization).
N₂ is a number of antenna ports in a second antenna port dimension (having the same antenna polarization).
P_{CSI-RS} is a number of CSI-RS ports configured to the UE.
N₃ is a number of SBs for PMI reporting or number of FD units or number of FD components (that comprise the CSI reporting band) or a total number of precoding matrices indicated by the PMI (one for each FD unit/component).
aᵢ is a 2N₁N₂×1 (Eq. 1) or N₁N₂×1 (Eq. 2) column vector, or aᵢ is a P_{CSIRS}×1 (Eq. 1) or

$$\frac{{P}_{CSIRS}}{2} \times 1$$

port selection column vector, where a port selection vector is a defined as a vector which contains a value of 1 in one element and zeros elsewhere.
b_{f} is a N₃×1 column vector.
c_{l,i,f} is a complex coefficient.

In a variation, when the UE reports a subset K<2 LM coefficients (where K is either fixed, configured by the gNB 102 or reported by the UE 116), then the coefficient c_{l,i,f} in precoder equations Eq. 1 or Eq. 2 is replaced with x_{l,i,f}×c_{l,i,f}, where:
x_{l,i,f}=1 if the coefficient c_{l,i,f} is reported by the UE according to some embodiments of the present disclosure.
x_{l,i,f}=0 otherwise (i.e., c_{l,i,f} is not reported by the UE).

The indication whether x_{l,i,f}=1 or 0 is according to one or more embodiments described in the present disclosure. For example, it can be via a bitmap.

In a variation, the precoder equations Eq. 1 or Eq. 2 are respectively generalized to:

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤ M (where {Mᵢ} or ΣMᵢ is either fixed, configured by the gNB 102 or reported by the UE 116).

The columns of W^{l} are normalized to norm one. For rank R or R layers (υ=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is implied in the rest of the present disclosure. However, the embodiments of the present disclosure are general and are also application to Eq. 1, Eq. 3, and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. M<N₃, in an example, to report columns of B, the oversampled DFT codebook is used. For instance, b_{f}=W_{f}, where the quantity w_{f} is given by:

$${w}_{f} = {[ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & … & {e}^{j \frac{2 π . ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , υ} (where u is the RI or rank value) is given by:

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} , \\ where {y}_{t , l}^{( f )} = {e}^{j \frac{2 π {tn}_{3 , l}^{( f )}}{{N}_{3}}} and \\ {n}_{3 , l} = [ {n}_{3 , l}^{( 0 )} , … , {n}_{3 , l}^{( M - 1 )} ] where {n}_{3 , l}^{( f )} ∈ \{ 0 , 1 , … , {N}_{3} - 1 \} .$$

In another example, discrete cosine transform (DCT) basis is used to construct/report basis B for the 3^{rd} dimension. The m-th column of the DCT compression matrix is simply given by:

$${[ {W}_{f} ]}_{nm} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} , \\ and K = {N}_{3} , and m = 0 , … , {N}_{3} - 1.$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The present disclosure is applicable to any other basis vectors to construct/report A and B.

On a high level, a precoder W^{l} can be described as follows:

$$W = {A}_{l} {C}_{l} {B}_{l}^{H} = {W}_{1} {\tilde{W}}_{2} {W}_{f}^{H} , \qquad ( Eq . 5 )$$

where A=W₁ corresponds to the Rel. 15 W₁ in Type II CSI codebook (document and standard [8]), and B=W_{f}.

The Cₗ=\tilde{W}₂ matrix includes each of the called for linear combination coefficients (e.g., amplitude and phase or real or imaginary). Each reported coefficient (c_{l,i,f}=p_{l,i,f}ϕ_{l,i,f}) in W₂ is quantized as amplitude coefficient (p_{l,i,f}) and phase coefficient (p_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where:
p_{l,i,f}⁽¹⁾ is a reference or first amplitude which is reported using an A1-bit amplitude codebook where A1 belongs to {2, 3, 4}, and
p_{l,i,f}⁽²⁾ is a differential or second amplitude which is reported using a A2-bit amplitude codebook where A2≤A1 belongs to {2, 3, 4}.

The framework mentioned herein (equation 5) represents the precoding-matrices for multiple (N₃) FD units using a linear combination (double sum) over 2 L (or K1) SD beams/ports and My FD beams. This framework can also be used to represent the precoding-matrices in time domain (TD) by replacing the FD basis matrix W_{f} with a TD basis matrix Wₜ, wherein the columns of Wₜ comprises M_{υ} TD beams that represent some form of delays or channel tap locations. Hence, a precoder W^{l} can be described as follows:

$$W = {A}_{l} {C}_{l} {B}_{l}^{H} = {W}_{1} {\tilde{W}}_{2} {W}_{t}^{H} . \qquad ( Eq . 5 A )$$

In one example, the M_{υ} TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

The rest of the present disclosure is applicable to both space-frequency (equation 5) and space-time (equation 5A) frameworks.

In the present disclosure, the framework mentioned herein for CSI reporting based on space-frequency compression (equation 5) or space-time compression (equation 5A) frameworks can be extended in two directions:
time or Doppler domain compression (e.g., for moderate to high mobility UEs) and
joint transmission across multiple RRHs/TRP (e.g., for a DMIMO or multiple TRP systems).

FIG. 14 illustrates an example of a UE moving on a trajectory 1400 located in a distributed MIMO according to embodiments of the present disclosure. For example, trajectory 1400 located in a distributed MIMO can be implemented by the UE 116 of FIG. 3. This example is for illustration only and can be used without departing from the scope of the present disclosure.

While the UE (e.g., the UE 116) moves from a location A to another location B at high speed (e.g., 60 kmph), the UE measures the channel and the interference (e.g., via NZP CSI-RS resources and CSI interference measurement (CSI-IM) resources, respectively), and then uses them to determine/report CSI regarding CJT from multiple RRHs. The reported CSI can be based on a codebook, which includes components regarding both multiple RRHs, and time-/Doppler-domain channel compression.

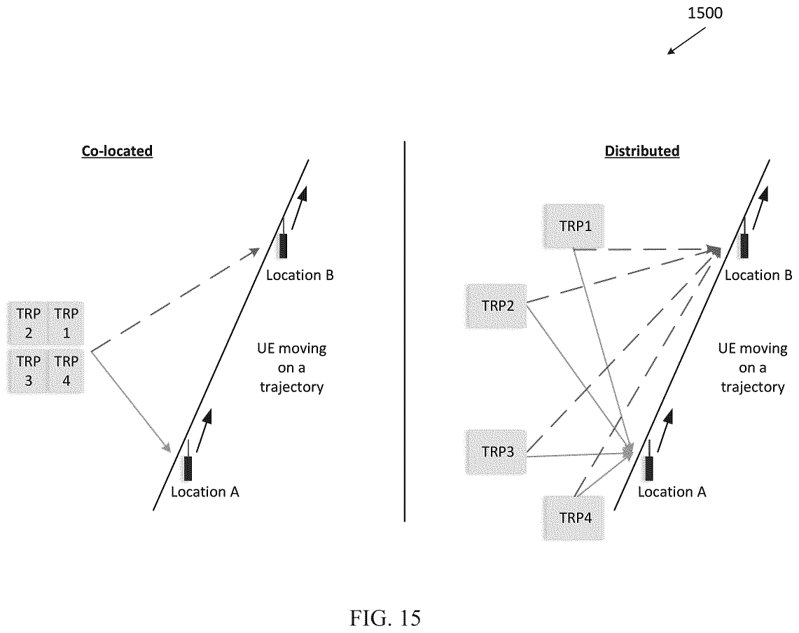

FIG. 15 illustrates examples of a UE moving on a trajectory 1500 located in co-located and distributed TRPs according to embodiments of the present disclosure. For example, trajectory 1500 located in co-located and distributed TRPs can be implemented by any of the UEs 111-116 of FIG. 1. This example is for illustration only and can be used without departing from the scope of the present disclosure.

In one example scenario, multiple TRPs can be co-located or distributed, and can serve static (non-mobile) or moving UEs. While the UE moves from a location A to another location B, the UE measures the channel, e.g., via NZP CSI-RS resources, (may also measure the interference, e.g., via CSI-IM resources or CSI-RS resources for interference measurement), uses the measurement to determine/report CSI evaluating joint transmission from multiple TRPs. The reported CSI can be based on a codebook. The codebook can include components evaluating multiple TRPs, and frequency/delay-domain channel profile and time/Doppler-domain channel profile.

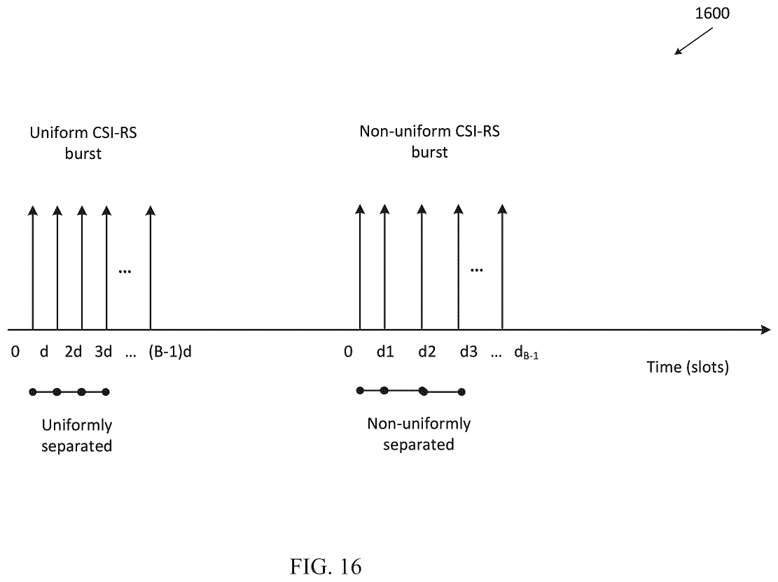

FIG. 16 illustrates an example of a timeline 1600 for a UE to receive NZP CSI-RS resource(s) bursts according to embodiments of the present disclosure. For example, timeline 1600 for a UE to receive NZP CSI-RS resource(s) bursts can be followed by the UE 116 of FIG. 3. This example is for illustration only and other embodiments can be used without departing from the scope of the present disclosure.

In one embodiment, a UE is configured to receive a burst of non-zero power (NZP) CSI-RS resource(s), referred to as CSI-RS burst for brevity, within B time slots comprising a measurement window, where B≥1. The B time slots can be accordingly to at least one of the following examples.
In one example, the B time slots are evenly/uniformly spaced with an inter-slot spacing d.
In one example, the B time slots can be non-uniformly spaced with inter-slot spacing e₁=d₁, e₂=d₂−d₁, e₃=d₃−d₂, . . . , so on, where eᵢ≠eⱼ for at least one pair (i,j) with i≠j.

The UE receives the CSI-RS burst, estimates the B instances of the DL channel measurements, and uses the channel estimates to obtain the Doppler component(s) of the DL channel. The CSI-RS burst can be linked to (or associated with) a single CSI reporting setting (e.g., via higher layer parameter (′SI-ReportConfig), wherein the corresponding CSI report includes an information about the Doppler component(s) of the DL channel.

Let hₜ be the DL channel estimate based on the CSI-RS resource(s) received in time slot t∈{0,1, . . . , B−1}. When the DL channel estimate in slot t is a matrix Gₜ of size N_{Rx}×N_{Tx}×N_{Sc}, then hₜ=vec(Gₜ), where N_{Rx}, N_{Tx}, and N_{Sc} are number of receive (Rx) antennae at the UE, number of CSI-RS ports measured by the UE, and number of subcarriers in frequency band of the CSI-RS burst, respectively. The notation vec(X) is used to denote the vectorization operation wherein the matrix X is transformed into a vector by concatenating the elements of the matrix in an order, for example, 1→2→3→ and so on, implying that the concatenation starts from the first dimension, then moves second dimension, and continues until the last dimension. Let H_{B}=[h₀ h₁ . . . h_{B-1}] be a concatenated DL channel. The Doppler component(s) of the DL channel can be obtained based on H_{B}. For example, H_{B} can be represented as CΦ^{H}=Σₛ₌₀^{N-1}cₛϕₛ^{H} where Φ=[ϕ₀ ϕ₁ . . . ϕ_{N-1}] is a Doppler domain (DD) basis matrix whose columns comprise basis vectors, C=[c₀ c₁ . . . c_{N-1}] is a coefficient matrix whose columns comprise coefficient vectors, and N<B is the number of DD basis vectors. Since the columns of H_{B} are likely to be correlated, a DD compression can be achieved when the value of N is small (compared to the value of B). In this example, the Doppler component(s) of the channel is represented by the DD basis matrix Φ and the coefficient matrix C.

When there are multiple TRPs/RRHs (N_{RRH}>1), the UE can be configured to measure the CSI-RS burst(s) according to at least one of the following examples.

In one example, the UE is configured to measure N_{RRH} CSI-RS bursts, one from each TRP/RRH. The N_{RRH} CSI-RS bursts can be overlapping in time (i.e., measured in same time slots). Or they can be staggered in time (i.e., measured in different time slots). Whether overlapping or staggered can be determined based on configuration. It can also depend on the total number of CSI-RS ports across RRHs/TRPs. When the total number of ports is small (e.g., <=32), they can overlap, otherwise (>32), they are staggered. The number of time instances B can be the same for each of the N_{RRH} bursts. Or the number B can be the same or different across bursts (or TRPs/RRHs).
In one example, each CSI-RS burst corresponds to a semi-persistent (SP) CSI-RS resource. The SP CSI-RS resource can be activated or/and deactivated based on a MAC CE or/and DCI based signaling. Additional details are as described in U.S. patent application Ser. No. 17/689,838 filed Mar. 8, 2022 (the '838 application), which is incorporated by reference in its entirety.
In one example, each CSI-RS burst corresponds to a group of B≥1 aperiodic (Ap) CSI-RS resources. The Ap-CSI-RS resources can be triggered via a DCI with slot offsets such that they can be measured in B different time slots. The rest of the details can be as described in the '838 application.
In one example, each CSI-RS burst corresponds to a periodic (P) CSI-RS resource. The P-CSI-RS resource can be configured via higher layer. The first measurement instance (time slot) and the measurement window of the CSI-RS burst (from the P-CSI-RS resource) can be fixed or configured. The rest of the details can be as described in the '838 application.
In one example, a CSI-RS burst can either be a P-CSI-RS, or SP-CSI-RS or Ap-CSI-RS resource.
   In one example, the time-domain behavior (P, SP, or Ap) of N_{RRH} CSI-RS bursts is the same.
   In one example, the time-domain behavior of N_{RRH} CSI-RS bursts can be the same or different.

In one example, the UE is configured to measure K≥ N_{RRH} CSI-RS bursts, where K=Σᵣ₌₁^{N}^{_{RRH}}Kᵣ and Kᵣ is a number of CSI-RS bursts associated with RRH/TRP r, where r∈{1, . . . , N_{RRH}}. Each CSI-RS burst is according to one or more examples described herein. When Kᵣ>1, multiple CSI-RS bursts are linked to (or associated with) a CSI reporting setting, i.e., the UE receives the Nᵣ CSI-RS bursts, estimates the DL channels, and obtains the Doppler component(s) of the channel using each of the Nᵣ CSI-RS bursts. The rest of the details can be as described in the '838 application.

In one example, the UE is configured to measure one CSI-RS burst across each of the N_{RRH} TRPs/RRHs. Let P be a number of CSI-RS ports associated with the NZP CSI-RS resource measured via the CSI-RS burst. The CSI-RS burst is according to one or more examples described herein. The total of P ports can be divided into N_{RRH} groups/subsets of ports and one group/subset of ports is associated with (or corresponds to) a TRP/RRH. Then, P=Σᵣ₌₁^{N}^{_{RRH}}Pᵣ and Pᵣ is a number of CSI-RS ports in the group/subset of ports associated with RRH/TRP r.
In one example, in each of the B time instances, a UE is configured to measure each groups/subsets of ports, i.e., in each time instance within the burst, the UE measures each of P ports (or N_{RRH} groups/subsets of ports).
In one example, a UE is configured to measure subsets/groups of ports across multiple time instances, i.e., in each time instance within the burst, the UE measures a subset of P ports or a subset of groups of ports (RRHs/TRPs).
   In one example, in each time instance, the UE measures only one group/subset of ports (1 TRP per time instance). In this case, B=N_{RRH}×C or B≥ N_{RRH}×C, where C is a number of measurement instances for each TRP/RRH.
   In one example, the UE is configured to measure one half of the port groups in a time instance, and the remaining half in another time instance.
      In one example, the two time instances can be consecutive, for example, the UE measures one half of port groups in even-numbered time instances, and the remaining half in the odd-numbered time instances.
      In one example, a first half of the time instances (e.g., 0,1, . . . , B/2−1) is configured to measure one half of the port groups, and the second half of the time instances (e.g., B/2, . . . . B−1) is configured to measure the remaining half of the port groups.

In one example, the UE is configured to measure multiple CSI-RS bursts, where each burst is according to one or more examples described herein. Multiple CSI-RS bursts are linked to (or associated with) a CSI reporting setting, i.e., the UE receives multiple CSI-RS bursts, estimates the DL channels, and obtains the Doppler component(s) of the channel using each of multiple CSI-RS bursts.

Let N₄ be the length of the DD basis vectors {ϕₛ}, e.g., each basis vector is a length N₄×1 column vector.

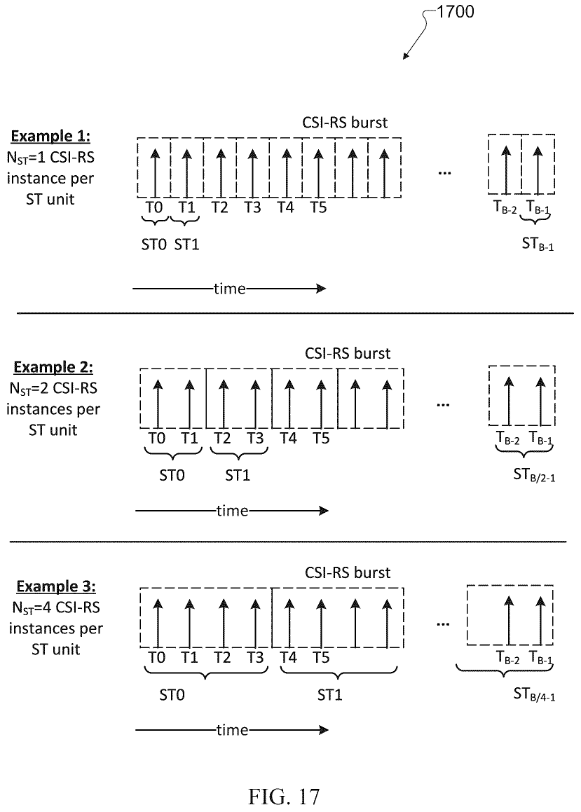

FIG. 17 illustrates examples of timelines 1700 for partitioned CSI-RS burst instances according to embodiments of the present disclosure. For example, timelines 1700 for partitioned CSI-RS burst instances. For example, timelines 1700 for partitioned CSI-RS burst instances can be followed by the UE 113 of FIG. 1. This example is for illustration only and other embodiments can be used without departing from the scope of the present disclosure.

In one embodiment, a UE is configured to determine a value of N₄ based on the value B (number of CSI-RS instances) in a CSI-RS burst and components across which the DD compression is performed, where each component corresponds to one or multiple time instances within the CSI-RS burst. In one example, N₄ is fixed (e.g., N₄=B) or configured (e.g., via RRC or MAC CE or DCI) or reported by the UE (as part of the CSI report). In one example, the B CSI-RS instances can be partitioned into sub-time (ST) units (instances), where each ST unit is defined as (up to) N_{ST} contiguous time instances in the CSI-RS burst. In this example, a component for the DD compression corresponds to a ST unit. With reference to FIG. 17, three examples of the ST units are shown. In the first example, each ST unit comprises N_{ST}=1 time instance in the CSI-RS burst. In the second example, each ST unit comprises N_{ST}=2 contiguous time instances in the CSI-RS burst. In the third example, each ST unit comprises N_{ST}=4 contiguous time instances in the CSI-RS burst.

The value of N_{ST} can be fixed (e.g., N_{ST}=1 or 2 or 4) or indicated to the UE (e.g., via higher layer RRC or MAC CE or DCI based signaling) or reported by the UE (e.g., as part of the CSI report). The value of N_{ST} (fixed or indicated or reported) can be subject to a UE capability reporting. The value of N_{ST} can also be dependent on the value of B (e.g., one value for a range of values for B and another value for another range of values for B).

When there are multiple TRPs/RRHs (N_{RRH}>1), the UE can be configured to determine a value of N₄ according to at least one of the following examples.
In one example, a value of N₄ is the same for each TRPs/RRHs.
In one example, a value of N₄ can be the same or different across TRPs/RRHs.

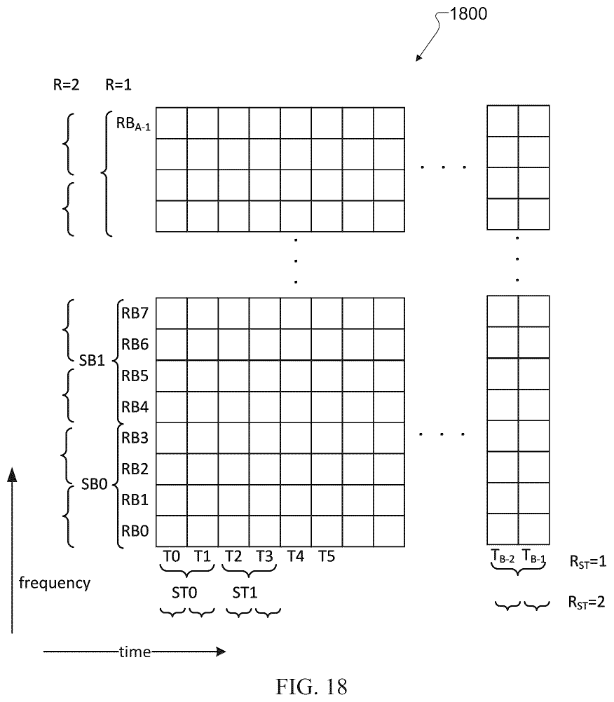

FIG. 18 is an example of a timeline 1800 for RB and SB partitions according to embodiments of the present disclosure. For example, timeline 1800 for RB and SB partitions can be followed by the UE 116 of FIG. 3. This example is for illustration only and other embodiments can be used without departing from the scope of the present disclosure.

In one embodiment, a UE is configured with J≥1 CSI-RS bursts (as illustrated herein) that occupy a frequency band and a time span (duration), wherein the frequency band comprises A RBs, and the time span comprises B time instances (of CSI-RS resource(s)). When J>1, the A RBs or/and B time instances can be aggregated across/CSI-RS bursts. In one example, the frequency band equals the CSI reporting band, and the time span equals the number of CSI-RS resource instances (across J CSI-RS bursts). Both can be configured to the UE for a CSI reporting, which can be based on the DD compression.

The UE is further configured to partition (divide) the A RBs into subbands (SBs) or/and the B time instances into sub-times (STs). The partition of A RBs can be based on a SB size value N_{SB}, which can be configured to the UE (cf. Table 5.2.1.4-2 of REF8). The partition of B time instances can be based either a ST size value N_{ST} or an r value, as described in this disclosure. With reference to FIG. 18, RB0, RB1, . . . , RB_{A-1} comprise A RBs, T₀, T₁, . . . , T_{B-1} comprise B time instances, the SB size N_{SB}=4, and the ST size N_{ST}=2.

When there are multiple TRPs/RRHs (N_{RRH}>1), the UE can be configured to determine subbands (SBs) or/and sub-times (STs) according to at least one of the following examples.
In one example, both subbands (SBs) or/and sub-times (STs) are the same for each TRPs/RRHs.
In one example, subbands (SBs) are the same for each TRPs/RRHs, but sub-times (STs) can be the same or different across RRHs/TRPs.
In one example, sub-times (STs) are the same for each TRPs/RRHs, but subbands (SBs) can be the same or different across RRHs/TRPs.
In one example, both sub-times (STs) and subbands (SBs) can be the same or different across RRHs/TRPs.

For illustration, one or more examples described herein are implied in the rest of this disclosure.

The CSI reporting is based on channel measurements (based on CSI-RS bursts) in three-dimensions (3D): the first dimension corresponds to SD comprising P_{CSIRS} CSI-RS antenna ports (in total across each of the N_{RRH} RRHs/TRPs), the second dimension corresponds to FD comprising N₃ FD units (e.g. SB), and the third dimension corresponds to DD comprising N₄ DD units (e.g. ST). The 3D channel measurements can be compressed using basis vectors (or matrices) similar to the Rel. 16 enhanced Type II codebook. Let W₁, W_{f}, and W_{d} respectively denote basis matrices whose columns comprise basis vectors for SD, FD, and DD.

In one embodiment, the DD compression (or DD component or W_{d} basis) can be turned OFF/ON from the codebook. When turned OFF, W_{d} can be fixed (hence not reported), e.g., W_{d}=1 (scalar 1) or W_{d}=[1, . . . , 1] (all-one vector) or

$${W}_{d} = \frac{1}{n}$$

[1, . . . , 1] (all-one vector) or

$${W}_{d} = I = [ \begin{matrix}1 & 0 & 0 \\ 0 & ⋱ & 0 \\ 0 & 0 & 1\end{matrix} ]$$

(identity matrix), where n is a scaling factor (e.g. n=N₄) or W_{d}=h_{d*}=[ϕ₀^{(d*)} ϕ₁^{(d*)} . . . ϕ_{N}_{₄}₋₁^{(d*)}], where d* is an index of a fixed DD basis vector h_{d*}. In one example, d*=0. In one example, when the DD basis vectors comprise an orthogonal DFT basis set, hat is a DD basis vector which corresponds to the DC component. When turned ON, W_{d} (DD basis vectors) is reported.
In one example, W_{d} is turned OFF/ON via an explicit signaling, e.g., an explicit RRC parameter.
In one example, W_{d} is turned OFF/ON via a codebook parameter. For example, similar to M=1 in Rel.17, when N=1 is configured, W_{d} is turned OFF, and when a value N>1 is configured, W_{d} is turned ON. Here, N denotes a number of DD basis vectors comprising columns of W_{d}.
In one example, the UE reports whether the DD component is turned OFF (not reported) or ON (reported). This reporting can be via a dedicated parameter (e.g., new UCI/CSI parameter). Or this reporting can be via an existing parameter (e.g., PMI component). A two-part UCI (cf. Rel. 15 NR) can be reused wherein the information whether W_{d} is turned OFF/ON is included in UCI part 1.
In one example, W_{d} is turned OFF/ON depending on the codebookType. When the codebookType is regular Type II codebook (similar to Rel 16 Type II codebook), W_{d} is turned ON, and when the codebookType is Type II port selection codebook (similar to Rel 17 Type II codebook), W_{d} is turned ON/OFF.

In one embodiment, a UE is configured with a CSI reporting based on a codebook (UE configured with higher layer parameter codebookType set to ‘typeII-Doppler-r18’), where the codebook comprises three bases (SD, FD, and DD/TD), and has a structure such that precoder for layer l is given by:

$${W}_{l} = {W}_{1} {{\tilde{W}}_{2} ( {W}_{f , d} )}^{H}$$

where:
W₁ includes SD basis vectors.
W_{f,d} includes FD basis vectors and TD/DD basis vectors.
\tilde{W}₂ is a coefficient matrix.

Let the length of each TD/DD basis vector be N₄, and the number of TD/DD basis vectors be Q. In one example, N₄ is configured, e.g., via higher-layer (RRC) signalling. In one example, Q is configured via RRC, or reported by the UE (e.g., as part of CSI report). In one example, the common (Rel. 16 enhanced Type II or Rel. 17 further enhanced Type II codebook) is used for reporting W₁, W_{f} (for each layer), and \tilde{W}₂ (for each layer).

In one example, at least one of the following examples is used/configured regarding W_{f,d}.

In one example, W_{f,d}=W_{f}⊗I, hence Wₗ=W₁\tilde{W}₂(W_{f}⊗I)^{H}, where the notation ⊗ is used for the Kronecker product. Note that when I is z×z identity matrix, then W_{f} ⊗I implies that W_{f} is repeated z times. Therefore, =W₁\tilde{W}₂(W_{f}⊗I)^{H} corresponds to one W₁, one W_{f}, and z number of W₂ reports. In one example, z corresponds to number of TD/DD units. In one example, z corresponds to value of N₄ (i.e., z=N₄). In one example, the common (Rel. 16 enhanced Type II or Rel. 17 further enhanced Type II codebook) is used for reporting one W₁, one W_{f} (for each layer), and multiple \tilde{W}₂ (for each layer).

In one example, W_{f,d}=W_{f}⊗W_{d}, hence Wₗ=W₁\tilde{W}₂(W_{f}⊗W_{d})^{H}. In one example, W_{d} comprises orthogonal DFT vectors as columns. The columns of the W_{d} correspond to the DD basis vectors.

In one example, W_{f,d} is according to one or more examples described herein based on a condition on the value of N₄. For example:
For N₄≤ x, W_{f,d} is according to one or more examples described herein.
For N₄>x, W_{f,d} is according to one or more examples described herein. In one example, W_{d} is an orthogonal DFT basis matrix commonly selected for each SD/FD bases reusing the common W₁ and W_{f} (Rel. 16 enhanced Type II or Rel. 17 further enhanced Type II codebook). In one example, DFT vectors for DD basis has a oversampling or rotation factor (O₄). In one example, O₄=4 or 1 is fixed. In one example, O₄ is identical (the same) for different SD components. In one example, O₄ is different for different SD components.

In one example, x is fixed, e.g., x=1 or x=2.

In one example, x is configured, e.g., via higher layer (RRC) or MAC CE or DCI (e.g., CSI request field triggering a Aperiodic CSI report).

In one example, x is reported by the UE, e.g., the UE (e.g., the UE 116) reports the value of x via UE capability reporting, or via CSI report.

When x=1, the condition is equivalent to the following:
For N₄=1, W_{f,d} is according to one or more examples described herein. In this case, since I=1, Wₗ=W₁\tilde{W}₂(W_{f})^{H}, i.e., there is no DD/TD basis, or it is replaced with a scalar value 1. In this case, the PMI reporting can be according to a common codebook (Rel. 16 enhanced Type II or Rel. 17 further enhanced Type II codebook).
For N₄>1, W_{f,d} is according to one or more examples described herein. In one example, W_{d} is an orthogonal DFT basis matrix commonly selected for each SD/FD bases reusing the common W₁ and W_{f} (Rel. 16 enhanced Type II or Rel. 17 further enhanced Type II codebook). In one example, DFT vectors for DD basis has a oversampling or rotation factor (O₄). In one example, O₄=4 or 1 is fixed. In one example, O₄ is identical (the same) for different SD components. In one example, O₄ is different for different SD components. In one example, only Q (denoting the number of selected DD basis vectors or columns of W_{d})>1 is allowed, i.e., the UE is expected to be configured with Q>1 (e.g., Q=2 or 3 or . . . ), or the UE is not expected to be configured with Q=1.

In one example, the set of supported values for N₄ includes {1,2,4,8}.

In one example, the set of supported values for Q includes {1,2} or {1,2,3} or {1,2,3,4}. In one example, when N₄=1, Q=1 or vice versa. In one example, Q=2 only when N₄≥2 or N₄≥ 3. In one example, Q=1,2 when N₄=2.

In one example, the value of number of P/SP NZP CSI-RS resources configured for CSI reporting including Doppler components is K=1. In one example, the value of number of Ap NZP CSI-RS resources configured for CSI reporting including Doppler components is K∈{4,8,12}. The spacing between two consecutive AP CSI-RS resources can be m∈{1,2}. The value of DD/TD unit d can be {1, m, p}, where p is the periodicity of the P/SP NZP CSI-RS resource. The CSI reporting window (number of slots), [l, . . . , l+W_{CSI}−1], where W_{CSI}=N₄d, and l=n_{ref} or n+δ, where n_{ref} is slot of the CSI reference resource associated with the CSI report, n is the UL slot in which the CSI reported, and δ∈{0,1,2} is parameter. The values of Q, N₄, K, m, d, δ are higher layer configured.

In this disclosure, K antenna port groups can be associated with at least one of the following examples:
Each of K antenna groups corresponds to a CSI-RS resource.
Each of K antenna groups corresponds to a CSI-RS resource set.
Each of K antenna groups correspond to an antenna group, including one or multiple antenna ports/elements.
Each of K antenna groups corresponds to a TRP/RRH.
Each of K antenna groups corresponds to an antenna panel, where the antenna panel includes multiple antenna ports/elements.
Each of K antenna groups corresponds to a cell.

In this disclosure, we simply use a term CSI-RS resource or resource or group for each of K antenna port groups, unless otherwise noted.

In one example, the number of antenna ports across K CSI-RS resources is the same. For example, each of the K CSI-RS resources can be associated with 2N₁N₂ antenna ports. In this case, the total number of antenna ports is 2KN₁N₂.

In one example, the number of antenna ports across K CSI-RS resources can be the same. For example, each of the K CSI-RS resources can be associated with 2N₁,N₂,r antenna ports. In this case, the total number of antenna ports is Σᵣ₌₁^{K}=2N_{1,r}N_{2,r}.

In one embodiment, a UE is configured with a codebook which includes spatial-domain (SD) basis vector selection component, inter-polarization co-phase component, and/or inter-resource co-phase component. The SD basis vector selection component W₁ is used to report/indicate L SD basis vectors and the inter-polarization co-phase component φ is used to report/indicate co-phase value(s) between cross-polarization antenna groups (i.e., a first antenna polarization group and a second antenna polarization group). The inter-resource co-phase component has two subcomponents, where a first sub-component Q₁ is used to determine co-phase value(s), which is not reported (i.e., fixed or configured), between resource antenna groups based on the SD basis vector selection and a second sub-component Q₂ is used to report/indicate another set of co-phase value(s) between resource antenna groups.

In another example, the inter-resource co-phase component has component Q₁ without component Q₂.

In another example, the inter-resource co-phase component has component Q₂ without component Q₁.

In another example, the inter-resource co-phase component has a combined component Q=Q₁Q₂.

Regarding the component Q₂ for co-phase value(s) c across resource antenna groups (CSI-RS resources), the co-phase value(s) is reported according to at least one of the following examples.

In one example, the co-phase value(s) is resource-common and layer-common, i.e., one co-phase value c is reported for all (CSI-RS) resources and for all layers.

In one example, the co-phase value(s) is resource-common yet layer-specific, i.e., one co-phase value cₗ is reported for all (CSI-RS) resources for each layer l.

In one example, the co-phase value(s) is resource-specific yet layer-common, i.e., one co-phase value cₗ is reported for all layers for each resource r of the K CSI-RS resources (or K-I CSI-RS resources, i.e., the case excluding a reference CSI-RS resource or a first/lowest indexed CSI-RS resource).

In one example, the co-phase value(s) is resource-specific and layer-specific, i.e., one co-phase value c_{r,l} is reported for each layer l and for each resource r of the K CSI-RS resources (or K-I CSI-RS resources, i.e., the case excluding a reference CSI-RS resource or a first/lowest indexed CSI-RS resource).

In one example, the co-phase value(s) is reported in a wideband (WB) manner only, i.e., one co-phase value for a resource and a layer is reported for all of the configured bandwidth.

In one example, the co-phase value(s) can be configured to report in a subband (SB) manner i.e., one co-phase value for a resource and a layer is reported for each SB in the configured bandwidth.

In one example, when the number of CSI-RS resources is in a set K, the co-phase value(s) can be configured to report in a SB manner, i.e., one co-phase value for a resource and a layer is reported for each SB in the configured bandwidth.
In one example, [symbol] includes 2.
In one example, [symbol] includes 2 and 3.

In one example, when the value of layer l is in a set [symbol] , the co-phase value(s) can be configured to report in a SB manner, i.e., one co-phase value for a resource and a layer is reported for each SB in the configured bandwidth.
In one example, [symbol] includes 1.
In one example, [symbol] includes 1 and 2.

In one example, when the value of layer l is in a set [symbol] and the number of CSI-RS resources is in a set [symbol] , the co-phase value(s) can be configured to report in a SB manner, i.e., one co-phase value for a resource and a layer is reported for each SB in the configured bandwidth.
In one example, [symbol] includes 2.
In one example, [symbol] includes 2 and 3.
In one example, [symbol] includes 1.
In one example, [symbol] includes 1 and 2.

In one example, the co-phase value c (cₗ or cᵣ or c_{r,l}) is selected from an alphabet set, where the alphabet set is an M-PSK, i.e.,

$$c = {ae}^{\frac{j 2 π n}{N}}$$

where n=0,1, . . . , M−1, N≥M and α is a phase value, e.g., α=e^{jθ}, where θ∈[0,2π].
In one example, N=2. In one example, N=4.
In one example, M=2. In another example M=4.
In one example, θ=0. In another example,

$$θ = \frac{π}{4} .$$

In another example.

$$θ = - \frac{π}{4} .$$

In one example, a codebook with W₁ according to one or more embodiments described herein can be based on Rel-15 Type-I codebook (or low-resolution codebook, 5.2.2.2.1 TS 38.214 [REF8]), where the codebook includes W₁ component according to one or more embodiments described herein and W₂ component for basis vector selection and/or co-phase selection (e.g., it can be called Rel-19 Type-I CSI).

In one example, a codebook with W₁ according to one or more embodiments described herein can be based on Rel-16 Type-II codebook (or high-resolution codebook, 5.2.2.2.5 TS 38.214 [REF8]), where the codebook includes W₁ component according to one or more embodiments described herein, W_{f} component for frequency-domain basis vector selection, and W₂ component for coefficient selection associated with (SD, FD) basis vector pairs (e.g., it can be called Rel-19 Type-II CSI).

In one example, a codebook with W₁ according to one or more embodiments described herein can be based on Rel-18 Type-II codebook (or high-resolution codebook, 5.2.2.2.8 TS 38.214 [REF8]), where the codebook includes W₁ component according to one or more embodiments described herein, We component for frequency-domain basis vector selection, and W₂ component for coefficient selection associated with (SD, FD) basis vector pairs (e.g., it can be called Rel-19 Type-II CSI).

In one embodiment, Type-I and Type-II CSI reporting can be (implicitly) configured from a same codebook via configuring the value of L. The codebook is designed based on W₁ described in one or more embodiments herein.

In one example, Type-I CSI reporting can be (implicitly) configured when L=1 is configured.

In one example, when L=1 is configured, FD compression component (i.e., W_{f} component, e.g., FD basis vector selection (i_{1,5}, i_{1,6}) and corresponding coefficient selection) is not applied in the codebook, i.e., W=W₁W₂.

In one example, when L=1 is configured, FD compression component (i.e., W_{f} component, e.g., FD basis vector selection (i_{1,5}, i_{1,6}) and corresponding coefficient selection) can be turned on or turned off by using a higher-layer parameter.

In one example, Type-II CSI reporting can be (implicitly) configured when L>1 is configured.

In one example, when L>1 is configured, FD compression component (i.e., W_{f} component, e.g., FD basis vector selection (i_{1,5}, i_{1,6}) and corresponding coefficient selection) can be turned on or turned off by using a higher-layer parameter.

In one example, when L>1 is configured, FD compression component (i.e., W_{f} component, e.g., FD basis vector selection (i_{1,5}, i_{1,6}) and corresponding coefficient selection) is turned on, i.e., W=W₁W₂W_{f}^{H}.

In one embodiment, Type-I and Type-II CSI reporting can be explicitly configured from a same codebook via a higher-layer parameter, e.g., codebookType, codebookMode, etc. The codebook is designed based on W₁ described in one or more embodiments herein.

In one example, for Type-I CSI reporting, the candidate values of L can include 1 and other value(s) larger than 1 (e.g., 4), and one out of L basis vectors is selected.

In another example, for Type-I CSI reporting, L=1 is only allowed to configure.

In one example, for Type-II CSI reporting, the candidate values of L can include values larger than 1 (e.g., 2,4,6).

In one example, for Type-II CSI reporting, the candidate values of L can include 1 and other values larger than 1 (e.g., 2,4,6).

In the examples described in this disclosure, the terminology of Type-I/Type-II should not be limited to the scope of the present disclosure. They can be denoted by different terminologies such as low-resolution/high-resolution CSI codebook, low-resolution/high-resolution CSI reporting, etc.

In one embodiment, the SD basis vector selection component W₁ has a block diagonal structure with 2K blocks for two polarization groups and K CSI-RS resources (or CSI-RS antenna port groups): e.g.,

$${W}_{1} = [ \begin{matrix}{B}_{0} & 0 & 0 & 0 & 0 \\ 0 & {B}_{1} & 0 & 0 & 0 \\ 0 & 0 & ⋱ & 0 & 0 \\ 0 & 0 & 0 & {B}_{2 K - 2} & 0 \\ 0 & 0 & 0 & 0 & {B}_{2 K - 1}\end{matrix} ]$$

where Bₙ=[b_{n,0}, b_{n,1}, . . . , b_{n,L-1}] is a SD basis vector group for each diagonal block n and L is the number of SD basis vectors in the group.

In one example, the SD basis vector group is polarization-common and CSI-RS-resource-specific, i.e., one SD basis vector group for both polarization for each CSI-RS resource: e.g.,

$${W}_{1} = [ \begin{matrix}{B}_{0} & 0 & 0 & 0 & 0 \\ 0 & {B}_{0} & 0 & 0 & 0 \\ 0 & 0 & ⋱ & 0 & 0 \\ 0 & 0 & 0 & {B}_{K - 1} & 0 \\ 0 & 0 & 0 & 0 & {B}_{K - 1}\end{matrix} ]$$

where Bₙ=[b_{n,0}, b_{n,1}, . . . , b_{n,L-1}] is a common SD basis vector group for every two diagonal blocks, the CSI-RS port indexing order is in the order of (1^{st}-pol, 1^{st} CSI-RS resource), (2^{nd}-pol, 1^{st} CSI-RS resource), (1^{st}-pol, 2^{nd} CSI-RS resource), (2^{nd}_pol, 2^{nd} CSI-RS resource), . . . , (1^{st}_pol, K-th CSI-RS resource), (2^{nd}-pol, K-th CSI-RS resource), where n=0, . . . , K−1 and L is the number of SD basis vectors in the group.

In another example, W₁ can be expressed as follows if the CSI-RS port indexing order is in the order of (1^{st}_pol, 1^{st} CSI-RS resource), (1^{st}_pol, 2^{nd} CSI-RS resource), . . . , (1^{st}-pol, K-th CSI-RS resource), (2^{nd}-pol, 1^{st} CSI-RS resource), (2^{nd}-pol, 2^{nd} CSI-RS resource), . . . , (2^{nd}-pol, K-th CSI-RS resource):

$${W}_{1} = [ \begin{matrix}{B}_{0} & 0 & 0 & 0 & 0 & 0 \\ 0 & ⋱ & 0 & 0 & 0 & 0 \\ 0 & 0 & {B}_{K - 1} & 0 & 0 & 0 \\ 0 & 0 & 0 & {B}_{0} & 0 & 0 \\ 0 & 0 & 0 & 0 & ⋱ & 0 \\ 0 & 0 & 0 & 0 & 0 & {B}_{K - 1}\end{matrix} ]$$

In one example, the SD basis vector group is polarization-specific and CSI-RS-resource-common, i.e., one SD basis vector group for CSI-RS resources for each polarization: e.g.,

$${W}_{1} = [ \begin{matrix}{B}_{0} & 0 & 0 & 0 & 0 \\ 0 & {B}_{1} & 0 & 0 & 0 \\ 0 & 0 & ⋱ & 0 & 0 \\ 0 & 0 & 0 & {B}_{0} & 0 \\ 0 & 0 & 0 & 0 & {B}_{1}\end{matrix} ]$$

where Bₙ=[b_{n,0}, b_{n,1}, . . . , b_{n,L-1}] is a SD basis vector group for CSI-RS resources for each polarization n, the CSI-RS port indexing order is in the order of (1^{st}_pol, 1^{st} CSI-RS resource), (2^{nd}-pol, 1^{st} CSI-RS resource), (1^{st}-pol, 2^{nd} CSI-RS resource), (2^{nd}-pol, 2^{nd} CSI-RS resource), . . . , (1^{st}-pol, K-th CSI-RS resource), (2^{nd}-pol, K-th CSI-RS resource), where n=0, 1 and L is the number of SD basis vectors in the group.

In another example, W₁ can be expressed as follows if the CSI-RS port indexing order is in the order of (1^{st}-pol, 1^{st} CSI-RS resource), (1^{st}_pol, 2^{nd} CSI-RS resource), . . . , (1^{st}-pol, K-th CSI-RS resource), (2^{nd}-pol, 1^{st} CSI-RS resource), (2^{nd}-pol, 2^{nd} CSI-RS resource), . . . , (2^{nd}_pol, K-th CSI-RS resource):

$${W}_{1} = [ \begin{matrix}{B}_{0} & 0 & 0 & 0 & 0 & 0 \\ 0 & ⋱ & 0 & 0 & 0 & 0 \\ 0 & 0 & {B}_{0} & 0 & 0 & 0 \\ 0 & 0 & 0 & {B}_{1} & 0 & 0 \\ 0 & 0 & 0 & 0 & ⋱ & 0 \\ 0 & 0 & 0 & 0 & 0 & {B}_{1}\end{matrix} ]$$

In one example, the SD basis vector group is polarization-common and CSI-RS-resource-common, i.e., one SD basis vector group for CSI-RS resources for both polarizations: e.g.,

$${W}_{1} = [ \begin{matrix}B & 0 & 0 & 0 & 0 \\ 0 & B & 0 & 0 & 0 \\ 0 & 0 & ⋱ & 0 & 0 \\ 0 & 0 & 0 & B & 0 \\ 0 & 0 & 0 & 0 & B\end{matrix} ]$$

where B=[b₀, b₁, . . . , b_{L-1}] is a common SD basis vector group for CSI-RS resources for both polarizations and L is the number of SD basis vectors in the group.

In one example, L SD basis vectors are layer-common and resource-common, i.e., L common SD basis vectors for layers and resources.

In one example, L SD basis vectors are layer-common and resource-specific, i.e., L common SD basis vectors for layers and for each resource.

In one example, L SD basis vectors are layer-specific and resource-common, i.e., L common SD basis vectors for resources and for each layer.

In one example, L SD basis vectors are layer-specific and resource-specific, i.e., L SD basis vectors for each resource and for each layer.

In one example, L is fixed, e.g., L=1, L=2, L=4, L=6, L=8 L=10, L=12, or L=16.

In one example, L depends on P_{CSIRS}, e.g., L≤sP where s<1, e.g., ½ or ¼.

In one example, L can be different across resources, e.g., Ly for n-th resource.

In one example, Lᵣ depends on P_{CSIRS,r}, e.g., Lᵣ≤sP_{CSIRS,r} or L=Σᵣ₌₁^{K}Lᵣ≤sP=sΣᵣ₌₁^{K}=1 Pᵣ where s<1, e.g., ½ or ¼.

In one example, L is configured via higher-layer signaling (e.g., RRC), e.g., L∈{1,4}, L∈{1,2,4}, L∈{1,2}, L∈{1,2,4,8}, L∈{1,2,4,6}, L∈{1,4,8,12}.

In one embodiment, the SD basis vector component W₁ is determined in a WB manner, i.e., L SD basis vector selection for configured subbands (i.e., wideband).

In one example, when the SD basis vector group is polarization-common and CSI-RS resource-common and L=1, the SD basis vector component W₁ includes only one SD basis vector for CSI-RS resources for both polarization for subbands.

In one embodiment, the SD basis vector component W₁ is determined in a WB+SB manner, where L SD basis vectors are selected for configured subbands and L₁ (≤ L) vectors out of the L SD basis vectors are selected for each subband. For example, L₁=1.

In one embodiment, the SD basis matrices comprising the diagonal blocks of the component W₁ have columns that are selected from a set of oversampled 2D DFT vectors. When the antenna port layout is the same across RRHs, for a given antenna port layout (N₁,N₂) and oversampling factors (O₁,O₂) for two dimensions, a DFT vector Vim can be expressed as follows.

$${v}_{l , m}^{{N}_{1} , {N}_{2}} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}} {u}_{m}}\end{matrix} ]}^{T}$$

$${u}_{m}^{{N}_{2}} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix}$$

where l∈{0,1, . . . , O₁N₁−1} and m∈{0,1, . . . , O₂N₂−1}. Here, (O₁,O₂) can be fixed, e.g. (1,1), (2,2), (2,1), (2,2), (4,1), or (4,4), or configured. (O₁,O₂) can be different across resources. (O₁,O₂) can depend on (N₁,N₂). For example, OᵢNᵢ=v or ≤ v where v can be fixed, e.g., 64, 128 or configured.

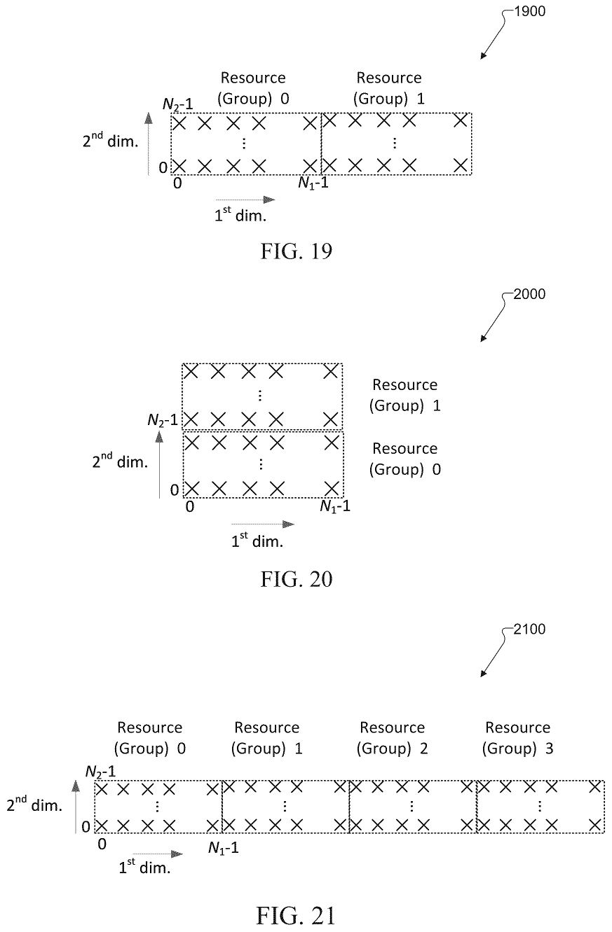

FIG. 19 illustrates a diagram of an example number of CSI-RS resource groups 1900 according to embodiments of the present disclosure. For example, CSI-RS resource groups 1900 can be utilized by any of the UEs 111-116 of FIG. 1. This example is for illustration only and other embodiments can be used without departing from the scope of the present disclosure.

In embodiment one, the first inter-resource co-phase component Q₁ includes co-phase values, which are fixed (not reported) and determined based on the SD basis vector component W₁ having N₁N₂-size 2D DFT vectors (i.e., low-resolution DFT vector), in order to generate/provide/construct a larger size (e.g., KN₁N₂) of 2D DFT vectors (high-resolution DFT vector). In one example, this embodiment is relevant to the case of one or more examples described herein, i.e., the SD basis vector group is common for CSI-RS resources and both polarizations.

When single DFT vector is selected/utilized in W₁, L=1 or L₁=1.

In one example, with reference to FIG. 19, when a number of CSI-RS resources (or CSI-RS port groups) is 2, (i.e., K=2), two N₁× N₂-size 2D DFT vectors (per polarization) can be utilized to form a single 2N₁×N₂-size 2D DFT vector based on the component Q₁. For example:

$${W}_{1} {Q}_{1} = [ \begin{matrix}{v}_{l , m}^{{N}_{1} , {N}_{2}} & 0 & 0 & 0 \\ 0 & {v}_{l , m}^{{N}_{1} , {N}_{2}} & 0 & 0 \\ 0 & 0 & {v}_{l , m}^{{N}_{1} , {N}_{2}} & 0 \\ 0 & 0 & 0 & {v}_{l , m}^{{N}_{1} , {N}_{2}}\end{matrix} ] [ \begin{matrix}1 & 0 \\ {e}^{j \frac{π l}{( {O}_{1} / 2 )}} & 0 \\ 0 & 1 \\ 0 & {e}^{j \frac{π l}{( {O}_{1} / 2 )}}\end{matrix} ] = [ \begin{matrix}{v}_{l , m}^{{N}_{1} , {N}_{2}} & 0 \\ {e}^{j \frac{π l}{( {O}_{1} / 2 )}} \cdot {v}_{l , m}^{{N}_{1} , {N}_{2}} & 0 \\ 0 & {v}_{l , m}^{{N}_{1} , {N}_{2}} \\ 0 & {e}^{j \frac{π l}{( {O}_{1} / 2 )}} \cdot {v}_{l , m}^{{N}_{1} , {N}_{2}}\end{matrix} ] = [ \begin{matrix}{v}_{l , m}^{2 {N}_{1} , {N}_{2}} & 0 \\ 0 & {v}_{l , m}^{2 {N}_{1} , {N}_{2}}\end{matrix} ]$$

Note that the resultant vector v_{l,m}^{2N}^{₁}^{,N}^{₂} is 2D DFT vectors of the size of 2N₁×N₂ with oversampling factors O₁/2 and O₂, where O₁≥2 and O₂≥1. In one example, O₁=1.

In one example, when O₁=1, the value of

$${e}^{j \frac{π l}{( {O}_{1} / 2 )}} = 1 .$$

In one example, when O₁=2, the value of

$${e}^{j \frac{π l}{( {O}_{1} / 2 )}}$$

in Q₁ is determined by index l in the component W₁:
1 for l=0,2,4, . . . , N₁O₁−2; and/or
−1 for l=1,3,5, . . . , N₁O₁−1.

$${e}^{j \frac{π l}{( {O}_{1} / 2 )}}$$

In one example, when O₁=4, the value of in Q₁ is determined by index l in the component W₁:
1 for l=0,4,8 . . . , N₁O₁−4;
i for l=1,5,9, . . . , N₁O₁−3;
−1 for l=2,6,10, . . . , N₁O₁−2; and/or
−i for l=3,7,11, . . . , N₁O₁−1.

$${e}^{j \frac{π l}{( {O}_{1} / 2 )}}$$

Similarly, when 01 is given (e.g., 6, 8, 10, 12, . . . ), the value of in Q₁ can be determined by index l in the component W₁.

Although various embodiments express the example/equation on W₁ Q₁ herein the CSI-RS port indexing order is in the order of (1^{st}-pol, 1^{st} CSI-RS resource), (1^{st}-pol, 2^{nd} CSI-RS resource), (2^{nd}-pol, 1^{st} CSI-RS resource), (2^{nd}-pol, 2^{nd} CSI-RS resource), it can be straightforwardly extended when different CSI-RS port indexing order is applied. In other words, any permutations of W₁ and/or Q₁ also belong to the present disclosure. For example, it can be expressed as

$${W}_{1} {Q}_{1} = [ \begin{matrix}{v}_{l , m}^{{N}_{1} , {N}_{2}} & 0 & 0 & 0 \\ 0 & {v}_{l , m}^{{N}_{1} , {N}_{2}} & 0 & 0 \\ 0 & 0 & {v}_{l , m}^{{N}_{1} , {N}_{2}} & 0 \\ 0 & 0 & 0 & {v}_{l , m}^{{N}_{1} , {N}_{2}}\end{matrix} ] [ \begin{matrix}1 & 0 \\ 1 & 0 \\ 0 & {e}^{j \frac{π l}{( {O}_{1} / 2 )}} \\ 0 & {e}^{j \frac{π l}{( {O}_{1} / 2 )}}\end{matrix} ] = [ \begin{matrix}{v}_{l , m}^{{N}_{1} , {N}_{2}} & 0 \\ {v}_{l , m}^{{N}_{1} , {N}_{2}} & 0 \\ 0 & {e}^{j \frac{π l}{( {O}_{1} / 2 )}} \cdot {v}_{l , m}^{{N}_{1} , {N}_{2}} \\ 0 & {e}^{j \frac{π l}{( {O}_{1} / 2 )}} \cdot {v}^{{N}_{1} , {N}_{2 ]}}\end{matrix} ] ,$$

the CSI-RS port indexing order is in the order of (1^{st}_pol, 1^{st} CSI-RS resource), (2^{nd}-pol, 1^{st} CSI-RS resource), (1^{st}_pol, 2^{nd} CSI-RS resource), (2^{nd}_pol, 2^{nd} CSI-RS resource). Hereafter, in this disclosure, we express equations using the order of (1^{st}-pol, 1^{st} CSI-RS resource), (1^{st}-pol, 2^{nd} CSI-RS resource), . . . , (1^{st}-pol, K-th CSI-RS resource), (2^{nd}-pol, 1^{st} CSI-RS resource), (2^{nd}-pol, 2^{nd} CSI-RS resource), . . . , (2^{nd}-pol, K-th CSI-RS resource) for the sake of simplicity and the purpose of illustration.

FIG. 20 illustrates a diagram of an example number of CSI-RS resource groups 2000 according to embodiments of the present disclosure. For example, CSI-RS resource groups 2000 can be utilized by the UE 116 of FIG. 3. This example is for illustration only and other embodiments can be used without departing from the scope of the present disclosure.

In one example, with reference to FIG. 20, when a number of CSI-RS resources (or CSI-RS port groups) is 2, (i.e., K=2), two N₁×N₂-size 2D DFT vectors (per polarization) can be utilized to form a single N₁×2N₂-size 2D DFT vector based on the component Q₁. For example:

$${W}_{1} {Q}_{1} = [ \begin{matrix}{v}_{l , m}^{{N}_{1} , {N}_{2}} & 0 & 0 & 0 \\ 0 & {v}_{l , m}^{{N}_{1} , {N}_{2}} & 0 & 0 \\ 0 & 0 & {v}_{l , m}^{{N}_{1} , {N}_{2}} & 0 \\ 0 & 0 & 0 & {v}_{l , m}^{{N}_{1} , {N}_{2}}\end{matrix} ] [ \begin{matrix}1 & 0 \\ {e}^{j \frac{π m}{( {O}_{2} / 2 )}} & 0 \\ 0 & 1 \\ 0 & {e}^{j \frac{π m}{( {O}_{2} / 2 )}}\end{matrix} ] = [ \begin{matrix}{v}_{l , m}^{{N}_{1} , {N}_{2}} & 0 \\ {e}^{j \frac{π m}{( {O}_{2} / 2 )}} \cdot {v}_{l , m}^{{N}_{1} , {N}_{2}} & 0 \\ 0 & {v}_{l , m}^{{N}_{1} , {N}_{2}} \\ 0 & {e}^{j \frac{π m}{( {O}_{2} / 2 )}} \cdot {v}_{l , m}^{{N}_{1} , {N}_{2}}\end{matrix} ] .$$

By taking a permutation operation P (which is also fixed operation) for W₁Q₁, it can be expressed as, e.g.,

$$P {W}_{1} {Q}_{1} = [ \begin{matrix}{ν}_{l , m}^{{N}_{1} , 2 {N}_{2}} & 0 \\ 0 & {ν}_{l , m}^{{N}_{1} , 2 {N}_{2}}\end{matrix} ] .$$

For example,

$$P = [ \begin{matrix}X & 0 \\ 0 & X\end{matrix} ]$$

where:

$$X = [ \begin{matrix}{I}_{{N}_{2}} & 0 & 0 & 0 \\ 0 & 0 & {I}_{{N}_{2}} & 0 \\ 0 & {I}_{{N}_{2}} & 0 & 0 \\ 0 & 0 & 0 & {I}_{{N}_{2}}\end{matrix} ] for the case of {N}_{1} = 2.$$

$$X = [ \begin{matrix}{I}_{{N}_{2}} & 0 & 0 & 0 & 0 & 0 & 0 & 0 \\ 0 & 0 & 0 & 0 & {I}_{{N}_{2}} & 0 & 0 & 0 \\ 0 & {I}_{{N}_{2}} & 0 & 0 & 0 & 0 & 0 & 0 \\ 0 & 0 & 0 & 0 & 0 & {I}_{{N}_{2}} & 0 & 0 \\ 0 & 0 & {I}_{{N}_{2}} & 0 & 0 & 0 & 0 & 0 \\ 0 & 0 & 0 & 0 & 0 & 0 & {I}_{{N}_{2}} & 0 \\ 0 & 0 & 0 & {I}_{{N}_{2}} & 0 & 0 & 0 & 0 \\ 0 & 0 & 0 & 0 & 0 & 0 & 0 & {I}_{{N}_{2}}\end{matrix} ] for the case of {N}_{1} = 4 .$$

X can be extended in the same way for the case of N₁=6,8,10,12,14,16, . . .
   where I_{N}_{₂} is an N₂× N₂ identity matrix.

Note that the resultant vector v_{l,m}^{N}^{₁}^{,2N}^{₂} is 2D DFT vectors of the size of N₁×2N₂ with oversampling factors O₁ and O₂/2, where O₁≥1 and O₂≥2. In one example, O₂=1.

In one example, when O₂=1, the value of

$${e}^{j \frac{π m}{( {O}_{2} / 2 )}} = 1 .$$

In one example, when O₂=2, the value of

$${e}^{j \frac{π m}{( {O}_{2} / 2 )}} in {Q}_{1}$$

is determined by index m in the component W₁:
1 for m=0,2,4, . . . , N₂O₂−2; and/or
−1 for m=1,3,5, . . . , N₂O₂−1.

$${e}^{j \frac{π m}{( {O}_{2} / 2 )}}$$

In one example, when 02=4, the value of in Q₁ is determined by index m in the component W₁:
1 for m=0,4,8 . . . , N₂O₂−4;
i for m=1,5,9, . . . , N₂O₂−3;
−1 for m=2,6,10, . . . , N₂O₂−2; and/or
−i for m=3,7,11, . . . , N₂O₂−1.

Similarly, when O₂ is given (e.g., 8), the value of

$${e}^{j \frac{π m}{( {O}_{2} / 2 )}}$$

in Q₁ can be determined by index
in the component W₁.

FIG. 21 illustrates a diagram of an example number of CSI-RS resource groups 2100 according to embodiments of the present disclosure. For example, CSI-RS resource groups 2100 can be utilized by the UE 111 of FIG. 1. This example is for illustration only and other embodiments can be used without departing from the scope of the present disclosure.

In one example, with reference to FIG. 21, when a number of CSI-RS resources (or CSI-RS port groups) is 4, (i.e., K=4), four N₁× N₂-size 2D DFT vectors (per polarization) can be utilized to form a single 4N₁×N₂-size 2D DFT vector based on the component Q₁. For example:

W₁Q₁

$${W}_{1} \text{} {Q}_{1} = [ \begin{matrix}{v}_{l , m}^{{N}_{1} , {N}_{2}} & 0 & 0 & 0 & 0 & 0 & 0 & 0 \\ 0 & {v}_{l , m}^{{N}_{1} , {N}_{2}} & 0 & 0 & 0 & 0 & 0 & 0 \\ 0 & 0 & {v}_{l , m}^{{N}_{1} , {N}_{2}} & 0 & 0 & 0 & 0 & 0 \\ 0 & 0 & 0 & {v}_{l , m}^{{N}_{1} , {N}_{2}} & 0 & 0 & 0 & 0 \\ 0 & 0 & 0 & 0 & {v}_{l , m}^{{N}_{1} , {N}_{2}} & 0 & 0 & 0 \\ 0 & 0 & 0 & 0 & 0 & {v}_{l , m}^{{N}_{1} , {N}_{2}} & 0 & 0 \\ 0 & 0 & 0 & 0 & 0 & 0 & {v}_{l , m}^{{N}_{1} , {N}_{2}} & 0 \\ 0 & 0 & 0 & 0 & 0 & 0 & 0 & {v}_{l , m}^{{N}_{1} , {N}_{2}}\end{matrix} ] [ \begin{matrix}1 & 0 \\ {e}^{j \frac{π l}{( {O}_{1} / 4 ) 2}} & 0 \\ {e}^{j \frac{π l}{( {O}_{1} / 4 )}} & 0 \\ {e}^{j \frac{3 π l}{( {O}_{1} / 4 ) 2}} & 0 \\ 0 & 1 \\ 0 & {e}^{j \frac{π l}{( {O}_{1} / 4 ) 2}} \\ 0 & {e}^{j \frac{π l}{( {O}_{1} / 4 )}} \\ 0 & {e}^{j \frac{3 π l}{( {O}_{1} / 4 ) 2}}\end{matrix} ] = [ \begin{matrix}{v}_{l , m}^{{N}_{1} , {N}_{2}} & 0 \\ {e}^{j \frac{π l}{( {O}_{1} / 4 ) 2}} \cdot {v}_{l , m}^{{N}_{1} , {N}_{2}} & 0 \\ {e}^{j \frac{π l}{( {O}_{1} / 4 )}} \cdot {v}_{l , m}^{{N}_{1} , {N}_{2}} & 0 \\ {e}^{j \frac{3 π l}{( {O}_{1} / 4 ) 2}} \cdot {v}_{l , m}^{{N}_{1} , {N}_{2}} & 0 \\ 0 & {v}_{l , m}^{{N}_{1} , {N}_{2}} \\ 0 & {e}^{j \frac{π l}{( {O}_{1} / 4 ) 2}} \cdot {v}_{l , m}^{{N}_{1} , {N}_{2}} \\ 0 & {e}^{j \frac{π l}{( {O}_{1} / 4 )}} \cdot {v}_{l , m}^{{N}_{1} , {N}_{2}} \\ 0 & {e}^{j \frac{3 π l}{( {O}_{1} / 4 ) 2}} \cdot {v}_{l , m}^{{N}_{1} , {N}_{2}}\end{matrix} ] = [ \begin{matrix}{v}_{l , m}^{4 {N}_{1} , {N}_{2}} & 0 \\ 0 & {v}_{l , m}^{4 {N}_{1} , {N}_{2}}\end{matrix} ]$$

Note that the resultant vector v_{l,m}^{4N}^{₁}^{,N}^{₂} is 2D DFT vectors of the size of 4N₁× N₂ with oversampling factors O₁/4 and O₂, where O₁≥4 and O₂≥1. In one example, O₁=1, 2, or 3.

In one example, when O₁=4, the values of

$$( {e}^{j \frac{π l}{( {O}_{1} / 4 ) 2}} , {e}^{j \frac{π l}{( {O}_{1} / 4 )}} , {e}^{j \frac{3 π l}{( {O}_{1} / 4 ) 2}} )$$

in Q₁ is determined by index l in the component W₁:
(1,1,1) for l=0,4,8 . . . , N₁O₁−4;
(i,−1,−i) for l=1,5,9, . . . , N₁O₁−3;
(−1,1,−1) for l=2,6,10, . . . , N₁O₁−2; and/or
(−i,−1, i) for l=3,7,11, . . . , N₁O₁−1.

Similarly, when O₁ is given (e.g., 8,12, . . . ), the values of

$$( {e}^{j \frac{π l}{( {O}_{1} / 4 ) 2}} , {e}^{j \frac{π l}{( {O}_{1} / 4 )}} , {e}^{j \frac{3 π l}{( {O}_{1} / 4 ) 2}} )$$

in Q₁ can be determined by index l in the component W₁.

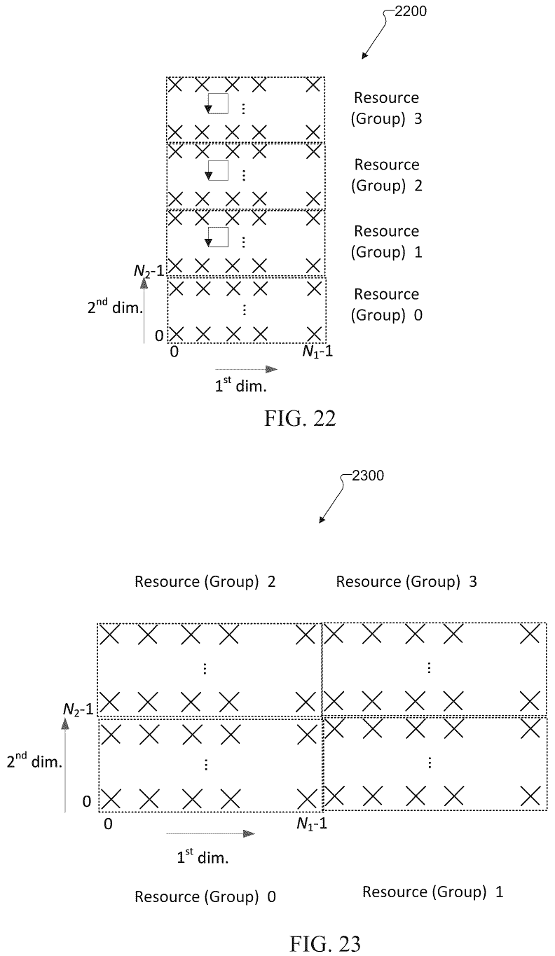

FIG. 22 illustrates a diagram of an example number of CSI-RS resource groups 2200 according to embodiments of the present disclosure. For example, CSI-RS resource groups 2200 can be utilized by any of the UEs 111-116 of FIG. 1. This example is for illustration only and other embodiments can be used without departing from the scope of the present disclosure.

In example, with reference to FIG. 22, when a number of CSI-RS resources (or CSI-RS port groups) is 4, (i.e., K=4), four N₁× N₂-size 2D DFT vectors (per polarization) can be utilized to form a single N₁×4N₂-size 2D DFT vector based on the component Q₁. For example:

$$\begin{matrix}{W}_{1} {Q}_{1} = [ \begin{matrix}{v}_{l , m}^{{N}_{1} , {N}_{2}} & 0 & 0 & 0 & 0 & 0 & 0 & 0 \\ 0 & {v}_{l , m}^{{N}_{1} , {N}_{2}} & 0 & 0 & 0 & 0 & 0 & 0 \\ 0 & 0 & {v}_{l , m}^{{N}_{1} , {N}_{2}} & 0 & 0 & 0 & 0 & 0 \\ 0 & 0 & 0 & {v}_{l , m}^{{N}_{1} , {N}_{2}} & 0 & 0 & 0 & 0 \\ 0 & 0 & 0 & 0 & {v}_{l , m}^{{N}_{1} , {N}_{2}} & 0 & 0 & 0 \\ 0 & 0 & 0 & 0 & 0 & {v}_{l , m}^{{N}_{1} , {N}_{2}} & 0 & 0 \\ 0 & 0 & 0 & 0 & 0 & 0 & {v}_{l , m}^{{N}_{1} , {N}_{2}} & 0 \\ 0 & 0 & 0 & 0 & 0 & 0 & 0 & {v}_{l , m}^{{N}_{1} , {N}_{2}}\end{matrix} ] \\ [ \begin{matrix}1 & 0 \\ {e}^{j \frac{π m}{( {O}_{2} / 4 ) 2}} & 0 \\ {e}^{j \frac{π m}{( {O}_{2} / 4 )}} & 0 \\ {e}^{j \frac{3 π m}{( {O}_{2} / 4 ) 2}} & 0 \\ 0 & 1 \\ 0 & {e}^{j \frac{π m}{( {O}_{2} / 4 ) 2}} \\ 0 & {e}^{j \frac{π m}{( {O}_{2} / 4 )}} \\ 0 & {e}^{j \frac{3 π m}{( {O}_{2} / 4 ) 2}}\end{matrix} ] \\ = [ \begin{matrix}{v}_{l , m}^{{N}_{1} , {N}_{2}} & 0 \\ {e}^{j \frac{π m}{( {O}_{2} / 4 ) 2}} \cdot {v}_{l , m}^{{N}_{1} , {N}_{2}} & 0 \\ {e}^{j \frac{π m}{( {O}_{2} / 4 )}} \cdot {v}_{l , m}^{{N}_{1} , {N}_{2}} & 0 \\ {e}^{j \frac{3 π m}{( {O}_{2} / 4 ) 2}} \cdot {v}_{l , m}^{{N}_{1} , {N}_{2}} & 0 \\ 0 & {v}_{l , m}^{{N}_{1} , {N}_{2}} \\ 0 & {e}^{j \frac{π m}{( {O}_{2} / 4 ) 2}} \cdot {v}_{l , m}^{{N}_{1} , {N}_{2}} \\ 0 & {e}^{j \frac{π m}{( {O}_{2} / 4 )}} \cdot {v}_{l , m}^{{N}_{1} , {N}_{2}} \\ 0 & {e}^{j \frac{3 π m}{( {O}_{2} / 4 ) 2}} \cdot {v}_{l , m}^{{N}_{1} , {N}_{2}}\end{matrix} ]\end{matrix}$$

By taking a permutation operation P (which is also fixed operation) for W₁Q₁, it can be expressed as, e.g.,

$${PW}_{1} {Q}_{1} = [ \begin{matrix}{v}_{l , m}^{{N}_{1} , 4 {N}_{2}} & 0 \\ 0 & {v}_{l , m}^{{N}_{1} , 4 {N}_{2}}\end{matrix} ]$$

For example,

$$P = [ \begin{matrix}X & 0 \\ 0 & X\end{matrix} ]$$

where:

$$X = [ \begin{matrix}{I}_{{N}_{2}} & 0 & 0 & 0 & 0 & 0 & 0 & 0 \\ 0 & 0 & {I}_{{N}_{2}} & 0 & 0 & 0 & 0 & 0 \\ 0 & 0 & 0 & 0 & {I}_{{N}_{2}} & 0 & 0 & 0 \\ 0 & 0 & 0 & 0 & 0 & 0 & {I}_{{N}_{2}} & 0 \\ 0 & {I}_{{N}_{2}} & 0 & 0 & 0 & 0 & 0 & 0 \\ 0 & 0 & 0 & {I}_{{N}_{2}} & 0 & 0 & 0 & 0 \\ 0 & 0 & 0 & 0 & 0 & {I}_{{N}_{2}} & 0 & 0 \\ 0 & 0 & 0 & 0 & 0 & 0 & 0 & {I}_{{N}_{2}}\end{matrix} ] for the case of {N}_{1} = 2. \\ X = [ \begin{matrix}{I}_{{N}_{2}} & 0 & 0 & 0 & 0 & 0 & 0 & 0 & 0 & 0 & 0 & 0 & 0 & 0 & 0 & 0 \\ 0 & 0 & 0 & 0 & {I}_{{N}_{2}} & 0 & 0 & 0 & 0 & 0 & 0 & 0 & 0 & 0 & 0 & 0 \\ 0 & 0 & 0 & 0 & 0 & 0 & 0 & 0 & {I}_{{N}_{2}} & 0 & 0 & 0 & 0 & 0 & 0 & 0 \\ 0 & 0 & 0 & 0 & 0 & 0 & 0 & 0 & 0 & 0 & 0 & 0 & {I}_{{N}_{2}} & 0 & 0 & 0 \\ 0 & {I}_{{N}_{2}} & 0 & 0 & 0 & 0 & 0 & 0 & 0 & 0 & 0 & 0 & 0 & 0 & 0 & 0 \\ 0 & 0 & 0 & 0 & 0 & {I}_{{N}_{2}} & 0 & 0 & 0 & 0 & 0 & 0 & 0 & 0 & 0 & 0 \\ 0 & 0 & 0 & 0 & 0 & 0 & 0 & 0 & 0 & {I}_{{N}_{2}} & 0 & 0 & 0 & 0 & 0 & 0 \\ 0 & 0 & 0 & 0 & 0 & 0 & 0 & 0 & 0 & 0 & 0 & 0 & 0 & {I}_{{N}_{2}} & 0 & 0 \\ 0 & 0 & {I}_{{N}_{2}} & 0 & 0 & 0 & 0 & 0 & 0 & 0 & 0 & 0 & 0 & 0 & 0 & 0 \\ 0 & 0 & 0 & 0 & 0 & 0 & {I}_{{N}_{2}} & 0 & 0 & 0 & 0 & 0 & 0 & 0 & 0 & 0 \\ 0 & 0 & 0 & 0 & 0 & 0 & 0 & 0 & 0 & 0 & {I}_{{N}_{2}} & 0 & 0 & 0 & 0 & 0 \\ 0 & 0 & 0 & 0 & 0 & 0 & 0 & 0 & 0 & 0 & 0 & 0 & 0 & 0 & {I}_{{N}_{2}} & 0 \\ 0 & 0 & 0 & {I}_{{N}_{2}} & 0 & 0 & 0 & 0 & 0 & 0 & 0 & 0 & 0 & 0 & 0 & 0 \\ 0 & 0 & 0 & 0 & 0 & 0 & 0 & {I}_{{N}_{2}} & 0 & 0 & 0 & 0 & 0 & 0 & 0 & 0 \\ 0 & 0 & 0 & 0 & 0 & 0 & 0 & 0 & 0 & 0 & 0 & {I}_{{N}_{2}} & 0 & 0 & 0 & 0 \\ 0 & 0 & 0 & 0 & 0 & 0 & 0 & 0 & 0 & 0 & 0 & 0 & 0 & 0 & 0 & {I}_{{N}_{2}}\end{matrix} ] \\ for the case of {N}_{1} = 4.$$

X can be extended in the same way for the case of N₁=6,8,10,12,14,16, . . . where I_{N}_{₂} is an N₂×N₂ identity matrix.

Note that the resultant vector v_{l,m}⁴^{₁}^{,4N}^{₂} is 2D DFT vectors of the size of N₁×4N₂ with oversampling factors O₁ and O₂/4, where O₁≥1 and O₂≥4. In one example, O₂=1,2, or 3.

In one example, when O₂=4, the values of

$$( {e}^{j \frac{π m}{( {O}_{2} / 4 ) 2}} , {e}^{j \frac{π m}{( {O}_{2} / 4 )}} , {e}^{j \frac{3 π m}{( {O}_{2} / 4 ) 2}} )$$

in Q₁ is determined by index m in the component W₁:
(1,1,1) for m=0,4,8 . . . , N₂O₂−4;
(i,−1,−i) for m=1,5,9, . . . , N₂O₂−3;
(−1,1,−1) for m=2,6,10, . . . , N₂O₂−2; and/or
(−i,−1, i) for m=3,7,11, . . . , N₂O₂−1.

Similarly, when O₂ is given (e.g., 8), the values of

$$( {e}^{j \frac{π m}{( {O}_{2} / 4 ) 2}} , {e}^{j \frac{π m}{( {O}_{2} / 4 )}} , {e}^{j \frac{3 π m}{( {O}_{2} / 4 ) 2}} )$$

in Q₁ can be determined by index m in the component W₁.

FIG. 23 illustrates a diagram of an example number of CSI-RS resource groups 2300 according to embodiments of the present disclosure. For example, CSI-RS resource groups 2300 can be utilized by the UE 116 of FIG. 3. This example is for illustration only and other embodiments can be used without departing from the scope of the present disclosure.

In one example, with reference to FIG. 23, when a number of CSI-RS resources (or CSI-RS port groups) is 4, (i.e., K=4), four N₁× N₂-size 2D DFT vectors (per polarization) can be utilized to form a single 2N₁×2N₂-size 2D DFT vector based on the component Q₁. For example:

$$\begin{matrix}{W}_{1} {Q}_{1} = [ \begin{matrix}{v}_{l , m}^{{N}_{1} , {N}_{2}} & 0 & 0 & 0 & 0 & 0 & 0 & 0 \\ 0 & {v}_{l , m}^{{N}_{1} , {N}_{2}} & 0 & 0 & 0 & 0 & 0 & 0 \\ 0 & 0 & {v}_{l , m}^{{N}_{1} , {N}_{2}} & 0 & 0 & 0 & 0 & 0 \\ 0 & 0 & 0 & {v}_{l , m}^{{N}_{1} , {N}_{2}} & 0 & 0 & 0 & 0 \\ 0 & 0 & 0 & 0 & {v}_{l , m}^{{N}_{1} , {N}_{2}} & 0 & 0 & 0 \\ 0 & 0 & 0 & 0 & 0 & {v}_{l , m}^{{N}_{1} , {N}_{2}} & 0 & 0 \\ 0 & 0 & 0 & 0 & 0 & 0 & {v}_{l , m}^{{N}_{1} , {N}_{2}} & 0 \\ 0 & 0 & 0 & 0 & 0 & 0 & 0 & {v}_{l , m}^{{N}_{1} , {N}_{2}}\end{matrix} ] \\ [ \begin{matrix}1 & 0 \\ {e}^{j \frac{π l}{( {O}_{1} / 2 )}} & 0 \\ {e}^{j \frac{π m}{( {O}_{2} / 2 )}} & 0 \\ {e}^{j \frac{π l}{( {O}_{1} / 2 )}} {e}^{j \frac{π m}{( {O}_{2} / 2 )}} & 0 \\ 0 & 1 \\ 0 & {e}^{j \frac{π l}{( {O}_{1} / 2 )}} \\ 0 & {e}^{j \frac{π m}{( {O}_{2} / 2 )}} \\ 0 & {e}^{j \frac{π l}{( {O}_{1} / 2 )}} {e}^{j \frac{π m}{( {O}_{2} / 2 )}}\end{matrix} ] \\ = [ \begin{matrix}{v}_{l , m}^{{N}_{1} , {N}_{2}} & 0 \\ {e}^{j \frac{π l}{( {O}_{1} / 2 )}} \cdot {v}_{l , m}^{{N}_{1} , {N}_{2}} & 0 \\ {e}^{j \frac{π m}{( {O}_{2} / 2 )}} \cdot {v}_{l , m}^{{N}_{1} , {N}_{2}} & 0 \\ {e}^{j \frac{π l}{( {O}_{1} / 2 )}} {e}^{j \frac{π m}{( {O}_{2} / 2 )}} \cdot {v}_{l , m}^{{N}_{1} , {N}_{2}} & 0 \\ 0 & {v}_{l , m}^{{N}_{1} , {N}_{2}} \\ 0 & {e}^{j \frac{π l}{( {O}_{1} / 2 )}} \cdot {v}_{l , m}^{{N}_{1} , {N}_{2}} \\ 0 & {e}^{j \frac{π m}{( {O}_{2} / 2 )}} \cdot {v}_{l , m}^{{N}_{1} , {N}_{2}} \\ 0 & {e}^{j \frac{π l}{( {O}_{1} / 2 )}} {e}^{j \frac{π m}{( {O}_{2} / 2 )}} \cdot {v}_{l , m}^{{N}_{1} , {N}_{2}}\end{matrix} ] = \\ [ \begin{matrix}{v}_{l , m}^{2 {N}_{1} , {N}_{2}} & 0 \\ {e}^{j \frac{π m}{( {O}_{2} / 2 )}} \cdot {v}_{l , m}^{2 {N}_{1} , {N}_{2}} & 0 \\ 0 & {v}_{l , m}^{2 {N}_{1} , {N}_{2}} \\ 0 & {e}^{j \frac{π m}{( {O}_{2} / 2 )}} \cdot {v}_{l , m}^{2 {N}_{1} , {N}_{2}}\end{matrix} ]\end{matrix}$$

By taking a permutation operation P (which is also fixed operation) for W₁Q₁, it can be expressed as, e.g.,

$${PW}_{1} {Q}_{1} = [ \begin{matrix}{v}_{l , m}^{2 {N}_{1} , 2 {N}_{2}} & 0 \\ 0 & {v}_{l , m}^{2 {N}_{1} , 2 {N}_{2}}\end{matrix} ]$$

Similar to the approach on P shown in one or more examples described herein, P can be constructed.

Note that the resultant vector v_{l,m}^{2N}^{₁}^{,2N}^{₂} is 2D DFT vectors of the size of 2N₁×2N₂ with oversampling factors O₁/2 and O₂/2, where O₁≥2 and O₂≥2. In another example, O₁=1. In another example, O₂=1.

In one example, when O₁=O₂=2, the values of

$$( {e}^{j \frac{π l}{( {O}_{1} / 2 )}} , {e}^{j \frac{π m}{( {O}_{2} / 2 )}} , {e}^{j \frac{π l}{( {O}_{1} / 2 )}} {e}^{j \frac{π m}{( {O}_{2} / 2 )}} )$$

in Q₁ is determined by index (l,m) in the component W₁:
(1,1,1) for l=0,2,4 . . . , N₁O₁−2 and m=0,2,4 . . . , N₂O₂−2,
(1,−1,−1) for l=0,2,4 . . . , N₁O₁−2 and m=1,3,5 . . . , N₂O₂−1,
(−1,1,−1) for l=1,3,5 . . . , N₁O₁−1 and m=0,2,4 . . . , N₂O₂−2,
(−1,−1,1) for l=1,3,5 . . . , N₁O₁−1 and m=1,3,5 . . . , N₂O₂−1,

Similarly, when O₁ and O₂ are given (e.g., (4,4), (2,4), (2,6) . . . ), the values of

$$( {e}^{j \frac{π l}{( {O}_{1} / 2 )}} , {e}^{j \frac{π m}{( {O}_{2} / 2 )}} , {e}^{j \frac{π l}{( {O}_{1} / 2 )}} {e}^{j \frac{π m}{( {O}_{2} / 2 )}} )$$

in Q₁ can be determined by index (l,m) in the component W₁.

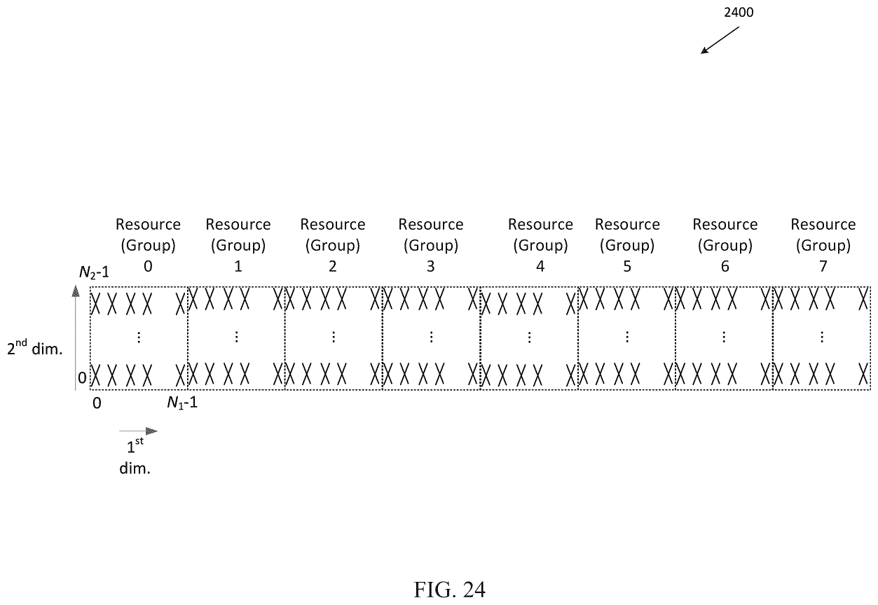

FIG. 24 illustrates a diagram of an example number of CSI-RS resource groups 2400 according to embodiments of the present disclosure. For example, CSI-RS resource groups 2400 can be utilized by the UE 111 of FIG. 1. This example is for illustration only and other embodiments can be used without departing from the scope of the present disclosure.

In one example, with reference to FIG. 24, when a number of CSI-RS resources (or CSI-RS port groups) is 8, (i.e., K=8), 8 N₁×N₂-size 2D DFT vectors (per polarization) can be utilized to form a single 8N₁×N₂-size 2D DFT vector based on the component Q₁. For example, similar to the approach shown in one or more examples described herein:

$${W}_{1} {Q}_{1} = [ \begin{matrix}{v}_{l , m}^{8 {N}_{1} , {N}_{2}} & 0 \\ 0 & {v}_{l , m}^{8 {N}_{1} , {N}_{2}}\end{matrix} ]$$

where W₁=diag(v_{l,m}^{N}^{₁}^{,N}^{₂}, . . . , v_{l,m}^{N}^{₁}^{,N}^{₂} and Q₁=diag(a,a) and a=

$${[ 1 , {e}^{j \frac{π l}{( {O}_{1} / 8 ) 4}} , {e}^{j \frac{π l}{( {O}_{1} / 8 ) 2}} , … {e}^{j \frac{7 π l}{( {O}_{1} / 8 ) 4}} ]}^{T}$$

and diag (A₁, A₂, . . . , A_{N}) is a block diagonal matrix including A₁, A₂, . . . , A_{N} as block diagonal entries.

Note that the resultant vector v_{l,m}^{8N}^{₁}^{,N}^{₂} is 2D DFT vectors of the size of 8N₁×N₂ with oversampling factors O₁/8 and O₂, where O₁≥8 and O₂≥1. In another example, O₁=1,2, . . . , or 7.

In one example, for a given O₁, Q₁ is determined by index l in the component W₁ (similar to one or more examples described herein).

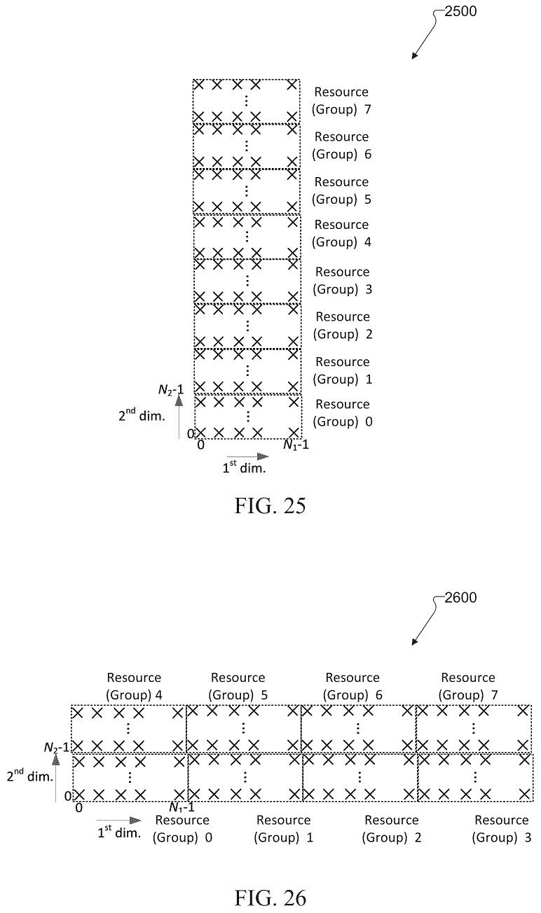

FIG. 25 illustrates a diagram of an example number of CSI-RS resource groups 2500 according to embodiments of the present disclosure. For example, CSI-RS resource groups 2500 can be utilized by any of the UEs 111-116 of FIG. 1. This example is for illustration only and other embodiments can be used without departing from the scope of the present disclosure.

In one example, with reference to FIG. 25, when a number of CSI-RS resources (or CSI-RS port groups) is 8, (i.e., K=8), 8 N₁× N₂-size 2D DFT vectors (per polarization) can be utilized to form a single N₁×8N₂-size 2D DFT vector based on the component Q₁. For example, similar to the approach in one or more examples described herein:

$${PW}_{1} {Q}_{1} = [ \begin{matrix}{v}_{l , m}^{{N}_{1} , 8 {N}_{2}} & 0 \\ 0 & {v}_{l , m}^{{N}_{1} , 8 {N}_{2}}\end{matrix} ]$$

where W₁=diag(v_{l,m}^{N}^{₁}^{,N}^{₂}, . . . , v_{l,m}^{N}^{₁}^{,N}^{₂}) and Q₁=diag(a,a) and

$$a = {[ 1 , {e}^{j \frac{π m}{( {O}_{2} / 8 ) 4}} , {e}^{j \frac{π m}{( {O}_{2} / 8 ) 2}} , … {e}^{j \frac{7 π m}{( {O}_{2} / 8 ) 4}} ]}^{T}$$

and diag (A₁, A₂, . . . , A_{N}) is a block diagonal matrix including A₁, A₂, . . . , A_{N} as block diagonal entries.

Similar to the approach on P shown in one or more examples described herein, P can be constructed.

Note that the resultant vector v_{l,m}^{N}^{₁}^{8,N}^{₂} is 2D DFT vectors of the size of N₁×8N₂ with oversampling factors O₁ and O₂/8, where O₁≥1 and O₂≥8. In another example, O₂=1,2, . . . , or 7.

In one example, for a given O₂, Q₁ is determined by index m in the component W₁ (similar to one or more examples described herein).

FIG. 26 illustrates a diagram of an example number of CSI-RS resource groups 2600 according to embodiments of the present disclosure. For example, CSI-RS resource groups 2600 can be utilized by the UE 116 of FIG. 3. This example is for illustration only and other embodiments can be used without departing from the scope of the present disclosure.

In one example, with reference to FIG. 26, when a number of CSI-RS resources (or CSI-RS port groups) is 8, (i.e., K=8), 8 N₁× N₂-size 2D DFT vectors (per polarization) can be utilized to form a single 4N₁×2N₂-size 2D DFT vector based on the component Q₁. For example, similar to the approach shown in one or more examples described herein:

$${PW}_{1} {Q}_{1} = [ \begin{matrix}{v}_{l , m}^{4 {N}_{1} , 2 {N}_{2}} & 0 \\ 0 & {v}_{l , m}^{4 {N}_{1} , 2 {N}_{2}}\end{matrix} ]$$

where W₁=diag (v_{l,m}^{N}^{₁}^{,N}^{₂}, . . . , v_{l,m}^{N}^{₁}^{,N}^{₂}) and Q₁=diag(a,a) and a=[a₁⊗a₂]^{T} and

$${a}_{1} = [ 1 , {e}^{j \frac{π m}{( {O}_{2} / 2 )}} ]$$

and

$${a}_{2} = [ 1 , {e}^{j \frac{π l}{( {O}_{1} / 4 ) 2}} , {e}^{j \frac{π l}{( {O}_{1} / 4 )}} , {e}^{j \frac{3 π l}{( {O}_{1} / 4 ) 2}} ]$$

and diag (A₁, A₂, . . . , A_{N}) is a block diagonal matrix including A₁, A₂, . . . , A_{N} as block diagonal entries.

Similar to the approach on P shown in one or more examples described herein, P can be constructed.

Note that the resultant vector v_{l,m}^{4N}^{₁}^{,2N}^{₂} is 2D DFT vectors of the size of 4N₁×2N₂ with oversampling factors O₁/4 and O₂/2, where O₁≥4 and O₂≥2. In another example, O₁=1,2, or 3. In another example, O₂=1.

In one example, for a given pair of (O₁,O₂), Q₁ is determined by index (l,m) in the component W₁ (similar to one or more examples described herein).

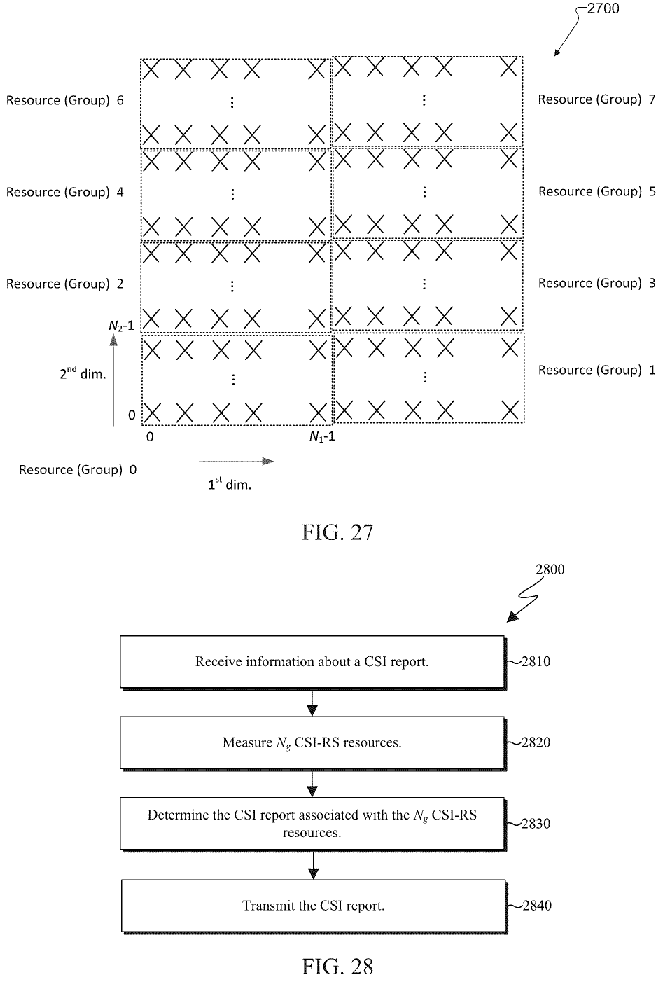

FIG. 27 illustrates a diagram of an example number of CSI-RS resource groups 2700 according to embodiments of the present disclosure. For example, CSI-RS resource groups 2700 can be utilized by the UE 111 of FIG. 1. This example is for illustration only and other embodiments can be used without departing from the scope of the present disclosure.

In one example, with reference to FIG. 27, when a number of CSI-RS resources (or CSI-RS port groups) is 8, (i.e., K=8), 8 N₁×N₂-size 2D DFT vectors (per polarization) can be utilized to form a single 2N₁×4N₂-size 2D DFT vector based on the component Q₁. For example, similar to the approach shown in one or more examples described herein:

$${PW}_{1} {Q}_{1} = [ \begin{matrix}{v}_{l , m}^{2 {N}_{1} , 4 {N}_{2}} & 0 \\ 0 & {v}_{l , m}^{2 {N}_{1} , 4 {N}_{2}}\end{matrix} ]$$

where W₁=diag (v_{l,m}^{N}^{₁}^{,N}^{₂}, . . . , v_{l,m}^{N}^{₁}^{,N}^{₂}) and Q₁=diag(a,a) and a=[a₁⊗a₂]^{T}

$${a}_{1} = [ 1 , {e}^{j \frac{π m}{( {O}_{2} / 4 ) 2}} , {e}^{j \frac{π m}{( {O}_{2} / 4 )}} , {e}^{j \frac{3 π m}{( {O}_{2} / 4 ) 2}} ]$$

and

$${a}_{2} = [ 1 , {e}^{j \frac{π l}{( {O}_{1} / 2 )}} ]$$

and diag (A₁, A₂, . . . , A_{N}) is a block diagonal and matrix including A₁, A₂, . . . , AN as block diagonal entries.

Similar to the approach on P shown in one or more examples described herein, P can be constructed.

Note that the resultant vector v_{l,m}^{2N}^{₁}^{,4N}^{₂} is 2D DFT vectors of the size of 2N₁×4N₂ with oversampling factors O₁/2 and O₂/4, where O₁≥2 and O₂≥4. In another example, O₁=1. In another example, O₂=1,2, or 3.

In one example, for a given pair of (O₁,O₂), Q₁ is determined by index (l,m) in the component W₁ (similar to one or more examples described herein).

In one example, similar to one or more examples described herein, when K=6, 10, 12, 14, 16, . . . , K N₁×N₂-size 2D DFT vectors (per polarization) can be utilized to form a single K₁N₁×K₂N₂-size 2D DFT vector based on the component Q₁, where K=K₁K₂.

In general, O₁≥M₁ and O₂≥M₂, where Mᵢ is number of resources or port groups in i-th dimension.

Or, In general, Oᵢ∈{1, 2, . . . . Mᵢ}, where Mᵢ is number of resources or port groups in i-th dimension.

TABLE 1

| Number of CSI-RS | | Number of resources: |
|---|---|---|
| antenna ports, P_{CSI-RS} | (N₁, N₂) | M₁ × M₂, (M₁, M₂) |
| 4 | (2, 1) | |
| 8 | (2, 2) | |
| | (4, 1) | |
| 12 | (3, 2) | |
| | (6, 1) | |
| 16 | (4, 2) | |
| | (8, 1) | |
| 24 | (4, 3) | |
| | (6, 2) | |
| | (12, 1) | |
| 32 | (4, 4) | |
| | (8, 2) | |
| | (16, 1) | |
| 64 | (1, 1) | (32, 1), (16, 2), (8, 4), (4, 8) |
| | | (2, 16), (1, 32) |
| | (2, 1) | (16, 1), (8, 2), (4, 4), (2, 8)(1, 16) |
| | (2, 2), (4, 1) | (8, 1), (4, 2), (2, 4), (1, 8) |
| | (4, 2), (8, 1) | (4, 1), (2, 2), (1, 4) |
| | (4, 4), (8, 2), (16, 1) | (2, 1), (1, 2) |
| 96 | (1, 1) | (48, 1), (24, 2), (16, 3), (12, 4), |
| | | (8, 6), (6, 8), (4, 12), (3, 16), |
| | | (2, 24), (1, 48) |
| | (2, 1) | (24, 1), (12, 2), (8, 3), (6, 4), |
| | | (4, 6), (3, 8), (2, 12), (1, 24) |
| | (2, 2), (4, 1) | (12, 1), (6, 2), (4, 3), (3, 4), |
| | | (2, 6), (1, 12) |
| | (3, 2), (6, 1) | (8, 1), (4, 2), (2, 4), (1, 8) |
| | (4, 2), (8, 1) | (6, 1), (3, 2), (2, 3), (1, 6) |
| | (4, 3), (6, 2), (12, 1) | (4, 1), (2, 2), (1, 4) |
| | (4, 4), (8, 2), (16, 1) | (3, 1), (1, 3) |
| 128 | (1, 1) | (64, 1), (32, 2), (16, 4), (8, 8), |
| | | (4, 16), (2, 32), (1, 64) |
| | (2, 1) | (32, 1), (16, 2), (8, 4), (4, 8) |
| | | (2, 16), (1, 32) |
| | (2, 2), (4, 1) | (16, 1), (8, 2), (4, 4), (2, 8)(1, 16) |
| | (4, 2), (8, 1) | (8, 1), (4, 2), (2, 4), (1, 8) |
| | (4, 4), (8, 2), (16, 1) | (4, 1), (2, 2), (1, 4) |
| | (8, 4), (16, 2), (32, 1) | (2, 1), (1, 2) |

In another embodiment, the second inter-resource co-phase component Q₂ includes co-phase values between resource antenna groups, where the co-phase values are quantized/reported as scalars using codebook(s)/set(s).

In one embodiment, for a codebook designed based on one or more embodiments described herein, oversampling factors O₁ and O₂ are designed/determined according to at least one of the following examples/embodiments.

In one embodiment, oversampling factors O₁ and O₂ are fixed.

In one example, O₁=1, O₁=2, O₁=3, O₁=4, O₁=5, . . . or O₁=128.

In one example, O₂=1, O₂=2, O₂=3, O₂=4, O₂=5, . . . or O₂=128.

In one example, (O₁,O₂)=(1,1), (O₁,O₂)=(1,2), . . . , (O₁,O₂)=(1,128), (O₁,O₂)=(2,1), (O₁,O₂)=(2,2), . . . , or (O₁,O₂)=(128,128).

In another embodiment, oversampling factors O₁ and O₂ can be configured by higher-layer signaling.

In one example, O₁ is in a set of Φ1, and one of the values in the set can be configured, where Φ₁ is a subset of {1,2,3,4,5, . . . ,128}. In one example, Φ₁={4,8}. In one example, Φ₁={1,2,4,8}. In one example, Φ₁={4,8,16,32}. In one example, Φ₁={4,8,16}. In one example, Φ₁={4,5,6,7}. In one example, Φ₁={4,6,8,10}. In one example, Φ₁={4,6,8,10,12,14,16}. In one example, Φ₁={2,4,6,8}.

In one example, O₂ is in a set of Φ₂, and one of the values in the set can be configured, where Φ₂ is a subset of {1,2,3,4,5, . . . ,128}. In one example, Φ₂={4,8}. In one example, Φ₂={1,2,4,8}. In one example, Φ₂={4,8,16,32}. In one example, Φ₂={4,8,16}. In one example, Φ₂={4,5,6,7}. In one example, Φ₂={4,6,8,10}. In one example, Φ₂={4,6,8,10,12,14,16}. In one example, Φ₂={2,4,6,8}.

In one example, (O₁,O₂) is in a set of Φ, and one of the values in the set can be configured, where Φ is a subset of {(1,1), (1,2), (1,3), . . . , (1,128), (2,1), (2,2), (2,3), . . . , (2,128), (3,1), . . . , (128,128)}. In one example, Φ={(4,4), (8,4), (4,8), (8,8)}. In one {(4,4), (8,4), (16,4), (4,8), (8,8), (16,8), (4,16), (8,16), (16,16)}.

In one embodiment, the supported values of oversampling factors O₁ and O₂ are determined based on (N₁,N₂).

In one example, (O₁,O₂)=(4,4) when N₁>1 and N₂>1. In one example, (O₁,O₂)=(4,1) when N₁>1 and N₂=1. For example, the supported values of oversampling factors O₁ and O₂ associated with (N₁,N₂) pairs follow a table including at least one of the rows described in the following table.

TABLE 2

| (N₁, N₂) | (O₁, O₂) |
|---|---|
| (2, 1) | (4, 1) |
| (2, 2) | (4, 4) |
| (4, 1) | (4, 1) |
| (3, 2) | (4, 4) |
| (6, 1) | (4, 1) |
| (4, 2) | (4, 4) |
| (8, 1) | (4, 1) |
| (4, 3) | (4, 4) |
| (6, 2) | (4, 4) |
| (12, 1) | (4, 1) |
| (4, 4) | (4, 4) |
| (8, 2) | (4, 4) |
| (16, 1) | (4, 1) |

In one example, the supported values of oversampling factors O₁ and O₂ are in a set of Φ_{N}_{₁}_{,N}_{₂}, where Φ_{N}_{₁}_{,N}_{₂} is a subset of {(1,1), (1,2), (1,3), . . . , (1,128), (2,1), (2,2), (2,3), . . . , (2,128), (3,1), . . . , (128,128)}. Any subset described herein about Φ can be an example for Φ_{N}_{₁}_{,N}_{₂}. For example, In one example, Φ_{N}_{₁}_{,N}_{₂}={(4,4), (8,4), (4,8), (8,8)}. In one example, Φ_{N}_{₁}_{,N}_{₂}={(4,4), (8,4), (16,4), (4,8), (8,8), (16,8), (4,16), (8,16), (16,16)}.

In one example, one set Φ_{N}_{₁}_{,N}_{₂} is associated with each (N₁,N₂), i.e., (N₁,N₂)-specific Φ_{N}_{₁}_{,N}_{₂}.

In one example, the set Φ_{N}_{₁}_{,N}_{₂} is common for (N₁,N₂) pairs, i.e., (N₁,N₂)-common Φ_{N}_{₁}_{,N}_{₂}=Φ,∀(N₁,N₂).

In one example, one of the values in Φ_{N}_{₁}_{,N}_{₂} can be configured for (O₁,O₂) for a given pair of (N₁,N₂). For example, (N₁,N₂) is configured with a higher-layer parameter and its corresponding Φ_{N}_{₁}_{,N}_{₂} is used by NW to configure one of the values in Φ_{N}_{₁}_{,N}_{₂} for (O₁,O₂).

In one example, a UE determines one of the values in Φ_{N}_{₁}_{,N}_{₂}, and includes the value (or indicator) in a CSI report. For example, (N₁,N₂) is configured with a higher-layer parameter and its corresponding Φ_{N}_{₁}_{,N}_{₂}, is used for the UE to determine one of the values in Φ_{N}_{₁}_{,N}_{₂} for (O₁,O₂) and report it.

In one example, (O₁,O₂) values in a subset of Φ_{N}_{₁}_{,N}_{₂} are supported values of a UE for (O₁,O₂), and the supported values (O₁,O₂) of the UE is informed/reported to the NW (e.g., the network 130) via UE capabilities. For example, (N₁,N₂) is configured with a higher-layer parameter and a subset of its corresponding Φ_{N}_{₁}_{,N}_{₂} that the UE supports is informed to the NW via UE capabilities, and the NW configures one of the values in the subset for (O₁,O₂) values.

In one embodiment, the supported values of oversampling factors O₁ and O₂ are determined based on (N̅₁,N̅₂), where N̅₁ and N̅₂ are total numbers of antenna ports associated with CSI-RS resources (or antenna groups) in a first dimension and a second dimension, respectively. In one example, N̅₁=KN₁ and N̅₂=N₂. In one example, N̅₁=N₁ and N̅₂=KN₂. For example, N̅₁=Σᵣ₌₁^{K}N_{1,r} and N₂=N₂. For example, N̅₁=N₁ and N̅₂=Σᵣ₋₁^{K}N_{2,r}. In one example, N̅₁=M₁N₁ and N̅₂=M₂N₂.

In one example, (O₁,O₂)=(4,4) when N_{1>1} and N_{2>1}. In one example, (O₁,O₂)=(4,1) when N₁>1 and N₂=1 (or when N₁=1 and N₂>1). For example, the supported values of oversampling factors O₁ and O₂ associated with (N₁,N₂) pairs follow a table including at least one of the rows described in the following table.

TABLE 3

| Number of CSI-RS | | |
|---|---|---|
| antenna ports, | (N̅₁, | (O₁, |
| P_{CSI-RS} | N̅₂) | O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |
| 64 | (8, 4) | (4, 4) |
| | (16, 2) | (4, 4) |
| | (32, 1) | (4, 1) |
| 96 | (8, 6) | (4, 4) |
| | (12, 4) | (4, 4) |
| | (16, 3) | (4, 4) |
| | (24, 2) | (4, 4) |
| | (48, 1) | (4, 1) |
| 128 | (8, 8) | (4, 4) |
| | (16, 4) | (4, 4) |
| | (32, 2) | (4, 4) |
| | (64, 1) | (4, 1) |
| 48 | (6, 4) | (4, 4) |
| | (8, 3) | (4, 4) |
| | (12, 2) | (4, 4) |
| | (24, 1) | (4, 1) |
| 72 | (6, 6) | (4, 4) |
| | (9, 4) | (4, 4) |
| | (12, 3) | (4, 4) |
| | (18, 2) | (4, 4) |
| | (36, 1) | (4, 1) |

In one example, the table herein can include the cases such that N̅₂≥N̅₁, e.g., (N̅₁, N̅₂)=(1,2),(1,4),(2,3),(1,6), . . . .

For each dimension i∈{1,2}, when Nᵢ>1, at least one of the following examples is used/configured regarding the total number of SD basis vectors across multiple resources.
In one example, the total number of SD basis vectors N̅ᵢOᵢ=MNᵢOᵢ.
In one example, the total number of SD basis vectors N̅ᵢOᵢ=MᵢNᵢOᵢ.
In one example, the total number of SD basis vectors N̅ᵢOᵢ=Σᵣ₌₁^{M}^{ᵢ}N_{i,r}Oᵢ.
In one example, the total number of SD basis vectors N̅ᵢŌᵢ=Σᵣ₌₁^{M}^{ᵢ}(N_{i,r}O_{i,r}).

Here, Mᵢ can be fixed (e.g., number of NZP CSI resources configured with the CSI reporting or associated with the codebook). Or Mᵢ can be determined implicitly (without any signaling) based on at least one codebook parameter (e.g., Nᵢ or/and Oᵢ). Or Mᵢ can be configured (e.g., via RRC) or MAC CE or DCI.

Here, Mᵢ can be fixed (e.g., number of NZP CSI resources configured with the CSI reporting or associated with the codebook). Or Mᵢ can be determined implicitly (without any signaling) based on at least one codebook parameter (e.g., Nᵢ or/and Oᵢ). Or Mᵢ can be configured (e.g., via RRC) or MAC CE or DCI.

Here, (N_{i,r}, O_{i,r}) can be fixed (e.g., from the common table). Or (N_{i,r}, O_{i,r}) can be determined implicitly (without any signaling) based on at least one codebook parameter (e.g., Mᵢ). Or (N_{i,r}, O_{i,r}) can be configured (e.g., via RRC) or MAC CE or DCI.

In one example, the supported values of oversampling factors O₁ and O₂ are in a set of Φ_{N̅}_{₁}_{,N̅}_{₂}, where Φ_{N̅}_{₁}_{,N̅}_{₂} is a subset of {(1,1), (1,2), (1,3), . . . , (1,128), (2,1), (2,2), (2,3), . . . , (2,128), (3,1), . . . , (128,128)}. Any subset described herein about Φ can be an example for Φ_{N̅}_{₁}_{,N̅}_{₂}. For example, In one example, Φ_{N̅}_{₁}_{,N̅}_{₂}={(4,4),(8,4),(4,8),(8,8)}. In one example, Φ_{N̅}_{₁}_{,N̅}_{₂}={(4,4), (8,4), (16,4), (4,8), (8,8), (16,8), (4,16), (8,16), (16,16)}.

In one example, the set Φ_{N̅}_{₁}_{,N̅}_{₂} is associated with (N̅₁,N̅₂), i.e., (N̅₁,N̅₂)-specific Φ_{N̅}_{₁}_{,N̅}_{₂}. In one example, the supported values of oversampling factors O₁ and O₂ follow a table including at least one of the rows in the following table.

TABLE 4

| Number of CSI-RS | | |
|---|---|---|
| antenna ports, | | |
| P_{CSI-RS} | (N̅₁, N̅₂) | (O₁, O₂) |
| 4 | (2, 1) | Φ_{2, 1} |
| 8 | (2, 2) | Φ_{2, 2} |
| | (4, 1) | Φ_{4, 1} |
| 12 | (3, 2) | Φ_{3, 2} |
| | (6, 1) | Φ_{6, 1} |
| 16 | (4, 2) | Φ_{4, 2} |
| | (8, 1) | Φ_{8, 1} |
| 24 | (4, 3) | Φ_{4, 3} |
| | (6, 2) | Φ_{6, 2} |
| | (12, 1) | Φ_{12, 1} |
| 32 | (4, 4) | Φ_{4, 4} |
| | (8, 2) | Φ_{8, 2} |
| | (16, 1) | Φ_{16, 1} |
| 64 | (8, 4) | Φ_{8, 4} |
| | (16, 2) | Φ_{16, 2} |
| | (32, 1) | Φ_{32, 1} |
| 96 | (8, 6) | Φ_{8, 6} |
| | (12, 4) | Φ_{12, 4} |
| | (16, 3) | Φ_{16, 3} |
| | (24, 2) | Φ_{24, 2} |
| | (48, 1) | Φ_{48, 1} |
| 128 | (8, 8) | Φ_{8, 8} |
| | (16, 4) | Φ_{16, 4} |
| | (32, 2) | Φ_{32, 2} |
| | (64, 1) | Φ_{64, 1} |
| 48 | (6, 4) | Φ_{6, 4} |
| | (8, 3) | Φ_{8, 3} |
| | (12, 2) | Φ_{12, 2} |
| | (24, 1) | Φ_{24, 1} |
| 72 | (6, 6) | Φ_{6, 6} |
| | (9, 4) | Φ_{9, 4} |
| | (12, 3) | Φ_{12, 3} |
| | (18, 2) | Φ_{18, 2} |
| | (36, 1) | Φ_{36, 1} |

In one example, the set Φ_{N̅}_{₁}_{,N̅}_{₂} is common for (N̅₁,N̅₂) pairs, i.e., (N̅₁,N̅₂)-common Φ_{N̅}_{₁}_{,N̅}_{₂}=Φ,∀(N̅₁,N̅₂).

In one example, one of the values in Φ_{N̅}_{₁}_{,N̅}_{₂} can be configured for (O₁,O₂) for a given pair of (N̅₁,N̅₂). For example, (N̅₁,N̅₂) is configured with a higher-layer parameter and its corresponding Φ_{N̅}_{₁}_{,N̅}_{₂} is used for NW to configure one of the values in Φ_{N̅}_{₁}_{,N̅}_{₂} for (O₁,O₂).

In one example, a UE determines one of the values in Φ_{N̅}_{₁}_{,N̅}_{₂} and includes the value (or indicator) in a CSI report. For example, (N̅₁,N̅₂) is configured with a higher-layer parameter and its corresponding Φ_{N̅}_{₁}_{,N̅}_{₂}, is used for the UE to determine one of the values in Φ_{N̅}_{₁}_{,N̅}_{₂} for (O₁,O₂) and report it.

In one example, (O₁,O₂) values in a subset of Φ_{N̅}_{₁}_{,N̅}_{₂} are supported values of a UE for (O₁,O₂), and the supported values (O₁,O₂) of the UE is informed/reported to the NW (e.g., the network 130) via UE capabilities. For example, (N̅₁,N̅₂) is configured with a higher-layer parameter and a subset of its corresponding Φ_{N̅}_{₁}_{,N̅}_{₂} that the UE supports is informed to the NW via UE capabilities, and the NW configures one of the values in the subset for (O₁,O₂) values.

In one embodiment, the supported values of oversampling factors O₁ and O₂ are determined based on (M₁,M₂), where M₁ and M₂ are numbers of CSI-RS resources or antenna groups in a first dimension and a second dimension, respectively.

In one example, O₁=c₁M₁, where c is a fixed value, e.g., c₁=4, or c₁>4, or c₁<4.

In one example, O₂=c₂M₂, where c is a fixed value, e.g., c₂=4, or c₂>4, or c₂<4.

In one example, O₁=c₁M₁, where c is a fixed value, e.g., c₁=4, or c₁>4, or c₁<4 for N₁>1 and O₁=1 for N₁=1.

In one example, O₂=c₂M₂, where c is a fixed value, e.g., c₂=4, or c₂>4, or c₂<4 for N₂>1 and O₂=1 for N₂=1.

For example, the supported values of oversampling factors O₁ and O₂ associated with (M₁,M₂) pairs follow a table including at least one of the rows described in the following table.

TABLE 5

| Number of CSI-RS | | |
|---|---|---|
| resources | | |
| K = M₁M₂ | (M₁, M₂) | (O₁, O₂) |
| 2 | (2, 1) | (4M₁, 1) |
| 4 | (2, 2) | (4M₁, 4M₂) |
| | (4, 1) | (4, 1) |
| 6 | (3, 2) | (4M₁, 4M₂) |
| | (6, 1) | (4M₁, 1) |
| 8 | (4, 2) | (4M₁, 4M₂) |
| | (8, 1) | (4M₁, 1) |
| 12 | (4, 3) | (4M₁, 4M₂) |
| | (6, 2) | (4M₁, 4M₂) |
| | (12, 1) | (4M₁, 1) |
| 16 | (4, 4) | (4M₁, 4M₂) |
| | (8, 2) | (4M₁, 4M₂) |
| | (16, 1) | (4M₁, 1) |
| 24 | (6, 4) | (4M₁, 4M₂) |
| | (8, 3) | (4M₁, 4M₂) |
| | (12, 2) | (4M₁, 4M₂) |
| | (24, 1) | (4M₁, 1) |
| 32 | (8, 4) | (4M₁, 4M₂) |
| | (16, 2) | (4M₁, 4M₂) |
| | (32, 1) | (4M₁, 1) |
| 48 | (8, 6) | (4M₁, 4M₂) |
| | (12, 4) | (4M₁, 4M₂) |
| | (16, 3) | (4M₁, 4M₂) |
| | (24, 2) | (4M₁, 4M₂) |
| | (48, 1) | (4M₁, 1) |
| 64 | (8, 8) | (4M₁, 4M₂) |
| | (16, 4 | (4M₁, 4M₂) |
| | (32, 2) | (4M₁, 4M₂) |
| | (64, 1) | (4M₁, 1) |

In one example, the table herein can include the cases such that M₂≥M₁, e.g., (M₁,M₂)=(1,2),(1,4),(2,3),(1,6), . . . .

In one example, O₁=c₁M₁, where c₁ is in a set of Φ₁ and one of the values in Φ₁ can be configured for O₁, where Φ₁ is a subset of {1,2,3,4,5, . . . ,128}. In one example, Φ₁={4,8}. In one example, Φ₁={1,2,4,8}. In one example, Φ_{1={}4,8,16,32}. In one example, Φ₁={4,8,16}. In one example, Φ₁={4,5,6,7}. In one example, Φ₁={4,6,8,10}. In one example, Φ₁={4,6,8,10,12,14,16}. In one example, Φ₁={2,4,6,8}.

In one example, O₂=c₂M₂, where c₂ is in a set of Φ₂ and one of the values in Φ₂ can be configured for O₂, where Φ2 is a subset of {1,2,3,4,5, . . . ,128}. In one example, Φ₂={4,8}. In one example, Φ₂={1,2,4,8}. In one example, Φ₂={4,8,16,32}. In one example, Φ₂={4,8,16}. In one example, Φ₂={4,5,6,7}. In one example, Φ₂={4,6,8,10}. In one example, Φ₂={4,6,8,10,12,14,16}. In one example, Φ₂={2,4,6,8}.

In one example, (O₁,O₂)=(c₁M₁,c₂M₂), where (c₁,c₂) is in a set of Φ, and one of the values in the set can Φ is a subset be configured, where of {(1,1), (1,2), (1,3), . . . , (1,128), (2,1), (2,2), (2,3), . . . , (2,128), (3,1), . . . , (128,128)}. In one example, Φ={(4,4),(8,4),(4,8),(8,8)}. In one example, Φ={(4,4), (8,4), (16,4), (4,8), (8,8), (16,8), (4,16), (8,16), (16,16)}.

FIG. 28 illustrates an example method 2800 performed by a UE in a wireless communication system according to embodiments of the present disclosure. The method 2800 of FIG. 28 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2800 is for illustration only and other embodiments can be used without departing from the scope of the present disclosure.

The method 2800 begins with the UE receiving information about a CSI report (2810). For example, in 2810, the information indicates the N_{g} CSI-RS resources, where N_{g}>1 and each of the N_{g} CSI-RS resources comprises 2N₁N₂ dual-polarized antenna ports. N₁ and N₂ are numbers of antenna ports associated with a same polarization in first and second dimensions, respectively.

The UE then measures N_{g} CSI-RS resources (2820) and determines the CSI report associated with the N_{g} CSI-RS resources (2830), for example, based on the information about the CSI report. For example, in 2830, the CSI report includes and/or the UE determines for the CSI report information of a SD basis vector vₗ that is common for two polarizations for the N_{g} CSI-RS resources for each layer l=1, . . . , v, where v≥1 is a rank value; information of an inter-resource co-phase value c_{r,l} for a CSI-RS resource ∀r≠r* with respect to a reference CSI-RS resource r* for each layer l=1, . . . , v; and information of an inter-polarization co-phase value φᵣ for a CSI-RS resource r. The UE then transmits the CSI report (2840).

In various embodiments, the UE determines the inter-resource co-phase value c_{r,l} for an entirety of a configured bandwidth. In various embodiments, the UE determines the inter-resource co-phase value c_{r,l} for each subband (SB) of a configured bandwidth. In various embodiments, the UE determines the inter-resource co-phase value c_{r,1} for each subband (SB) of a configured bandwidth, only when N_{g}=2 and v=1.

In various embodiments, the UE determines the inter-resource co-phase value c_{r,l} from an M-phase-shift-keying (PSK) codebook,

$${c}_{r , l} = {e}^{j θ} {e}^{\frac{j 2 π n}{N}} ,$$

n∈{0,1, . . . , M−1}, θ is a fixed value in [0, 2π], and N is a fixed value greater than or equal to M. In one example.

$$θ = \frac{π}{4} ,$$

### N=4, and M is 2 or 4.

In various embodiments, the UE determines the SD basis vector vₗ from a 2-dimensional (2D) discrete Fourier transform (DFT) codebook with size of N₁ and N₂ with oversampling factors O₁ and O₂, and

$${v}_{k , m}^{{N}_{1} , {N}_{2}} = {[ \begin{matrix}{u}_{m} & {e}^{j \frac{2 π k}{{O}_{1} {N}_{1}}} {u}_{m} & … & {e}^{j \frac{2 π k ( {N}_{1} - 1 )}{{O}_{1} {N}_{1}}} {u}_{m}\end{matrix} ]}^{T} , \\ {u}_{m}^{{N}_{2}} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

where k∈{0,1, . . . , O₁N₁−1} and m∈{0,1, . . . , O₂N₂−1}.

In various embodiments, the UE determines another inter-resource co-phase value d_{r,l} to construct a 2D DFT vector v_{k,m}^{M}^{₁}^{N}^{₁}^{,M}^{₂}^{N}^{₂} with oversampling factors O₁/M₁ and O₂/M₂, where M₁ and M₂ are numbers of CSI-RS resources in the first and second dimensions, respectively, and N_{g}=M₁M₂.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report, the information indicating N_{g} CSI reference signal (CSI-RS) resources, where N_{g}>1 and each of the N_{g} CSI-RS resources comprises 2N₁N₂ dual-polarized antenna ports, wherein N₁ and N₂ are numbers of antenna ports associated with a same polarization in first and second dimensions, respectively; and
a processor operably coupled to the transceiver, the processor, based on the information, configured to:
measure the N_{g} CSI-RS resources, and
determine the CSI report associated with the N_{g} CSI-RS resources, wherein the CSI report includes:
information of a spatial-domain (SD) basis vector vₗ that is common for two polarizations for the N_{g} CSI-RS resources for each layer l=1, . . . , v, where v≥1 is a rank value,
information of an inter-resource co-phase value c_{r,l} for a CSI-RS resource ∀r≠r* with respect to a reference CSI-RS resource r* for layer l, and
information of an inter-polarization co-phase value φᵣ for a CSI-RS resource r, wherein the transceiver is further configured to transmit the CSI report.

2. The UE of claim 1, wherein the processor is further configured to determine the inter-resource co-phase value c_{r,l} for each layer l=1, · · · , v for an entirety of a configured bandwidth.

3. The UE of claim 1, wherein the processor is further configured to determine the inter-resource co-phase value c_{r,l} common for all layers l=1, · · · , v for each subband (SB) of a configured bandwidth.

4. The UE of claim 1, wherein the processor is further configured to determine the inter-resource co-phase value c_{r,l} for each subband (SB) of a configured bandwidth, only when N_{g}=2 and v=1.

5. The UE of claim 1, wherein:
the processor is further configured to determine the inter-resource co-phase value c_{r,l} from an M-phase-shift-keying (PSK) codebook,
$${c}_{r , l} = {e}^{j θ} {e}^{\frac{j 2 π n}{N}} ,$$
n∈{0,1, . . . , M−1},
θ is a fixed value in [0, 2π], and
N is a fixed value greater than or equal to M.

6. The UE of claim 5, wherein
$$θ = \frac{π}{4} ,$$
N=4, and M is 2 or 4.

7. The UE of claim 1, wherein:
the processor is further configured to determine the SD basis vector vₗ from a 2-dimensional (2D) discrete Fourier transform (DFT) codebook with size of N₁ and N₂ with oversampling factors O₁ and O₂, and
$${v}_{k , m}^{{N}_{1} , {N}_{2}} = {[ \begin{matrix}{u}_{m} & {e}^{j \frac{2 π k}{{O}_{1} {N}_{1}}} {u}_{m} & … & {e}^{j \frac{2 π k ( {N}_{1} - 1 )}{{O}_{1} {N}_{1}}} {u}_{m}\end{matrix} ]}^{T} , \\ {u}_{m}^{{N}_{2}} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$
where x^{T} is a transpose of x, k∈{0,1, . . . , O₁N₁−1}, and m∈{0,1, . . . , O₂N₂−1}.

8. The UE of claim 7, wherein the processor is further configured to determine another inter-resource co-phase value d_{r,l} to construct a 2D DFT vector v_{k,m}^{M}^{₁}^{N}^{₁}^{,M}^{₂}^{N}^{₂} with oversampling factors O₁/M₁ and O₂/M₂, where M₁ and M₂ are numbers of CSI-RS resources in the first and second dimensions, respectively, and N_{g}=M₁M₂.

9. A base station (BS) comprising:
a processor; and
a transceiver operably coupled to the processor, the transceiver configured to:
transmit information about a channel state information (CSI) report, the information indicating N_{g} CSI reference signal (CSI-RS) resources, where N_{g}>1 and each of the N_{g} CSI-RS resources comprises 2N₁N₂ dual-polarized antenna ports, wherein N₁ and N₂ are numbers of antenna ports associated with a same polarization in first and second dimensions, respectively;
transmit on the N_{g} CSI-RS resources; and
receive the CSI report associated with the N_{g} CSI-RS resources,
wherein the CSI report includes:
information of a spatial-domain (SD) basis vector vₗ that is common for two polarizations for the N_{g} CSI-RS resources for each layer l=1, . . . , v, where v≥1 is a rank value,
information of an inter-resource co-phase value c_{r,l} for a CSI-RS resource ∀r≠r* with respect to a reference CSI-RS resource r* for layer l, and
information of an inter-polarization co-phase value φᵣ for a CSI-RS resource r.

10. The BS of claim 9, wherein the inter-resource co-phase value c_{r,l} for each layer l=1, · · · , v is for an entirety of a configured bandwidth.

11. The BS of claim 9, wherein the inter-resource co-phase value c_{r,l} is common for all layers l=1, · · · , v for each subband (SB) of a configured bandwidth.

12. The BS of claim 9, wherein the inter-resource co-phase value c_{r,l} is for each subband (SB) of a configured bandwidth, only when N_{g}=2 and v=1.

13. The BS of claim 9, wherein:
the inter-resource co-phase value c_{r,l} is from an M-phase-shift-keying (PSK) codebook,
$${c}_{r , l} = {e}^{j θ} {e}^{\frac{j 2 π n}{N}} ,$$
n∈{0,1, . . . , M−1},
θ is a fixed value in [0, 2π], and
N is a fixed value greater than or equal to M.

14. The BS of claim 13, wherein
$$θ = \frac{π}{4} ,$$
N=4, and M is 2 or 4.

15. The BS of claim 9, wherein:
the SD basis vector vₗ is from a 2-dimensional (2D) discrete Fourier transform (DFT) codebook with size of N₁ and N₂ with oversampling factors O₁ and O₂, and
$${v}_{k , m}^{{N}_{1} , {N}_{2}} = {[ \begin{matrix}{u}_{m} & {e}^{j \frac{2 π k}{{O}_{1} {N}_{1}}} {u}_{m} & … & {e}^{j \frac{2 π k ( {N}_{1} - 1 )}{{O}_{1} {N}_{1}}} {u}_{m}\end{matrix} ]}^{T} , \\ {u}_{m}^{{N}_{2}} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$
where x^{T} is a transpose of x, k∈{0,1, . . . , O₁N₁−1}, and m∈{0,1, . . . , O₂N₂−1}.

16. The BS of claim 15, wherein the CSI report includes another inter-resource co-phase value d_{r,l} for a 2D DFT vector v_{k,m}^{M}^{₁}^{N}^{₁}^{,M}^{₂}^{N}^{₂} with oversampling factors O₁/M₁ and O₂/M₂, where M₁ and M₂ are numbers of CSI-RS resources in the first and second dimensions, respectively, and N_{g}=M₁M₂.

17. A method performed by a user equipment (UE), the method comprising:
receiving information about a channel state information (CSI) report, the information indicating N_{g} CSI reference signal (CSI-RS) resources, where N_{g}>1 and each of the N_{g} CSI-RS resources comprises 2N₁N₂ dual-polarized antenna ports, wherein N₁ and N₂ are numbers of antenna ports associated with a same polarization in first and second dimensions, respectively; and
based on the information:
measuring the N_{g} CSI-RS resources, and
determining the CSI report associated with the N_{g} CSI-RS resources, wherein the CSI report includes:
information of a spatial-domain (SD) basis vector vₗ that is common for two polarizations for the N_{g} CSI-RS resources for each layer l=1, · · · , v, where v≥1 is a rank value,
information of an inter-resource co-phase value c_{r,l} for a CSI-RS resource ∀r≠r* with respect to a reference CSI-RS resource r* for layer l, and
information of an inter-polarization co-phase value φᵣ for a CSI-RS resource r; and
transmitting the CSI report.

18. The method of claim 17, wherein determining the CSI report further comprises determining the inter-resource co-phase value c_{r,l} for each layer l=1, · · · , v for an entirety of a configured bandwidth.

19. The method of claim 17, wherein determining the CSI report further comprises determining the inter-resource co-phase value c_{r,l} common for all layers l=1, · · · , v for each subband (SB) of a configured bandwidth.

20. The method of claim 17, wherein determining the CSI report further comprises determining the inter-resource co-phase value c_{r,l} for each subband (SB) of a configured bandwidth, only when N_{g}=2 and v=1.
